(19) United States
(12) Patent Application Publication
(10) Pub. No.: US 2023/0347537 A1
(43) Pub. Date: Nov. 2, 2023

(54) RAZOR BLADES

(71) Applicant: The Gillette Company LLC, Boston, MA (US)

(72) Inventors: John Lawrence Maziarz, Framingham, MA (US); Michael Joseph Baxter, Jamaica Plain, MA (US); Jonathan Raymond Petrie, Braintree, MA (US); Oliver Heinz Claus, Walpole, MA (US)

(21) Appl. No.: 18/124,047

(22) Filed: Mar. 21, 2023

Related U.S. Application Data
(60) Provisional application No. 63/326,219, filed on Mar. 31, 2022.

(51) Int. Cl. B26B 21/56; B26B 21/60

(52) U.S. Cl. CPC B26B 21/56; B26B 21/60

(57) ABSTRACT

A razor blade having a substrate with a cutting edge being defined by a sharpened tip and novel dimensions is provided. The substrate has dimensions of volumes, cross-sectional areas, and thicknesses at or near the ultimate tip (e.g., at a distance up to about 2 micrometers from the sharpened tip). The substrate is coated with one or more materials and has novel volumes, cross-sectional areas, and thicknesses at or near the ultimate tip (e.g., at a distance up to about 2 micrometers from the sharpened tip). The thickness of the substrate at 2 micrometers back from the ultimate tip is at or below about 0.977 micrometers and at or below about 1.173 micrometers for a coated substrate at the same distance. These dimensional values are measured robustly with an atomic force microscope and provide reduced cut forces for improved blade performance.

### CROSS REFERENCE TO RELATED APPLICATIONS

The present application is related to co-pending application serial numbers (63/326,210, 63/326,215, 63/326,222) filed on the same date and by the same Assignee as the present application, which are not admitted to being prior art with respect to the present invention by their mention in the cross-reference section. These co-pending applications are incorporated herein by reference in their entireties.

### FIELD OF THE INVENTION

This invention relates to razors and more particularly to razor blades with sharpened tips having improved geometric properties.

### BACKGROUND OF THE INVENTION

A razor blade is typically formed of a suitable substrate material such as stainless steel, and a cutting edge is formed with a wedge-shaped configuration with an ultimate tip having a radius. Hard coatings such as diamond, amorphous diamond, diamond-like carbon-(DLC) material, nitrides, carbides, oxides or ceramics are often used to improve strength, corrosion resistance and shaving ability, maintaining needed strength while permitting thinner edges with lower cutting forces to be used. Lubricious outer layers such as a polytetrafluoroethylene (PTFE) outer layer can be used to provide friction reduction. Interlayers of niobium, chromium, or titanium containing materials can aid in improving the binding between the substrate, typically stainless steel, and hard carbon coatings, such as DLC, while also reducing tip rounding.

It is desirable to improve the three-dimensional shape of the razor blade at the ultimate tip to reduce the cut force needed to cut hair. Such a reduction in cut force will lead to a more comfortable shave. It is desirable to improve both the substrate and coated substrate shape. It is also desirable to develop novel methods and instrumentation to be able to determine and obtain the optimal shape at the ultimate tip.

### SUMMARY OF THE INVENTION

The present invention provides a razor blade comprising a substrate. The substrate has a cutting edge being defined by a sharpened blade tip.

In accordance with an aspect of the present invention, a razor blade includes a substrate with a cutting edge being defined by an ultimate tip, the substrate includes a thickness of between 0.135 micrometers to 0.138 micrometers at a distance of 0.1 micrometers from the ultimate tip.

The substrate further includes a thickness of between 0.199 and 0.203 at a distance of 0.2 micrometers from the ultimate tip, a thickness of between 0.256 micrometers to 0.259 micrometers from the ultimate tip at a distance of 0.3 micrometers from the ultimate tip, a thickness of between 0.307 micrometers and 0.308 micrometers at a distance of 0.4 micrometers from the ultimate tip, and a thickness of between 0.351 micrometers and 0.355 micrometers at a distance of 0.5 micrometers from the ultimate tip.

The substrate further includes a thickness of between 0.392 and 0.398 at a distance of 0.6 micrometers from the ultimate tip, a thickness of between 0.431 micrometers to 0.439 micrometers from the ultimate tip at a distance of 0.7 micrometers from the ultimate tip, a thickness of between 0.470 micrometers and 0.479 micrometers at a distance of 0.8 micrometers from the ultimate tip, and a thickness of between 0.509 micrometers and 0.519 micrometers at a distance of 0.9 micrometers from the ultimate tip.

The substrate further includes a thickness of between 0.547 and 0.557 at a distance of 1 micrometer from the ultimate tip.

The substrate further includes a thickness of between 0.586 and 0.596 at a distance of 1.1 micrometers from the ultimate tip, a thickness of between 0.625 micrometers to 0.634 micrometers from the ultimate tip at a distance of 1.2 micrometers from the ultimate tip, a thickness of between 0.664 micrometers and 0.673 micrometers at a distance of 1.3 micrometers from the ultimate tip, and a thickness of between 0.705 micrometers and 0.712 micrometers at a distance of 1.4 micrometers from the ultimate tip.

The substrate further includes a thickness of 0.747 micrometers and 0.751 micrometers at a distance of 1.5 micrometers from the ultimate tip and a thickness of between 0.957 micrometers and 0.977 micrometers at a distance of 2 micrometers from the ultimate tip.

The thicknesses are measured using an Atomic Force Microscope.

A tip radius of the razor blade ranges from 100 to 500 Angstroms.

The substrate further includes an included angle of about 45 to about 65 degrees measured at a distance of 0.3 micrometers back from the sharpened tip.

In accordance with a second aspect of the present invention, a razor blade includes a coated substrate with a cutting edge being defined by a coated tip, the coated substrate having a thickness of between 0.167 micrometers to 0.212 micrometers at a distance of 0.1 micrometers from the coated tip.

The coated substrate further includes a thickness of between 0.244 and 0.308 at a distance of 0.2 micrometers from the coated tip.

The coated substrate further includes a thickness of between 0.412 micrometers to 0.525 micrometers at a distance of 0.5 micrometers from the coated tip, a thickness of between 0.616 micrometers to 0.758 micrometers at a distance of 1 micrometer from the coated tip.

The coated substrate further includes a thickness of between 0.810 micrometers to 0.962 micrometers at a distance of 1.5 micrometers from the coated tip, a thickness of between 1.023 micrometers to 1.173 micrometers at a distance of 2 micrometers from the coated tip.

The thicknesses are measured using an Atomic Force Microscope.

The coated substrate is coated with one or materials. The one or more materials includes niobium, chromium, carbon, boron, titanium, or polymer containing materials.

A wool cut force of the razor blade is about 0.9 lbs.

In accordance with yet another aspect of the present invention, a razor blade includes a substrate having a cutting edge with a sharpened tip, the substrate having a thickness measured at a distance of 4 microns from the sharpened tip of about 1.20 micrometers to about 1.60 micrometers.

The razor blade further includes a thickness measured at a distance of 1 micrometer back from the sharpened tip ranging from about 0.547 micrometers to about 0.557 micrometers, a thickness measured at a distance of 2 micrometers from the sharpened tip of about 0.957 micrometers to about 0.977 micrometers, and a thickness measured at a distance of 3 microns from the sharpened tip of 0.90 micrometers to 1.19 micrometers.

The thicknesses form a non-linear relationship relative to each other as measured using an Atomic Force Microscope.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In addition, the materials, methods, and examples are illustrative only and not intended to be limiting.

Other features and advantages of the invention will be apparent from the following detailed description, and from the claims.

### BRIEF DESCRIPTION OF DRAWINGS

While the specification concludes with claims particularly pointing out and distinctly claiming the subject matter that is regarded as the present invention, it is believed that the invention will be more fully understood from the following description taken in conjunction with the accompanying drawings.

FIG. 1 is a diagrammatic view illustrating a blade substrate geometry of the present invention.

FIG. 1A is a close-up view of section 1A of FIG. 1.

FIG. 2 is a graph illustrating the thickness edge profile of a razor blade substrate of the present invention compared to the prior art.

FIGS. 2A-2D are charts illustrating the statistical differences in data of present invention blades and the prior art.

FIG. 3 is a diagrammatic three-dimensional view illustrating the area of a blade substrate.

FIGS. 3A-3D are diagrammatic three-dimensional views illustrating the area profile of a razor blade edge substrate of the present invention.

FIG. 4 is a graph illustrating the area edge profile of a razor blade substrate of the present invention compared to the prior art.

FIGS. 4A-4D are charts illustrating the statistical differences in data of present invention blades and the prior art.

FIGS. 5-8 are diagrammatic three-dimensional views illustrating the volumes of the razor blade edge substrate of the present invention.

FIG. 9 is a graph illustrating the volume edge profile of a razor blade substrate of the present invention compared to the prior art.

FIGS. 9A-9D are charts illustrating the statistical differences in data of present invention blades and the prior art.

FIG. 10 is a diagrammatic view illustrating an alternate blade substrate geometry of the present invention.

FIG. 11 is a diagrammatic view illustrating a tip radius of a substrate in accordance with the present invention.

FIG. 12 is a diagrammatic view illustrating an included angle of a substrate in accordance with the present invention.

FIGS. 13A-13H are diagrammatic views illustrating a blade substrate with coatings deposited thereon in an alternate embodiment of the present invention.

FIG. 14 is a graph illustrating the thickness edge profile of a coated razor blade substrate of the present invention compared to the prior art.

FIG. 15 is a graph illustrating the cross-sectional area edge profile of a coated razor blade substrate of the present invention compared to the prior art.

FIG. 16 is a graph illustrating the volume edge profile of a coated razor blade substrate of the present invention compared to the prior art.

FIG. 17 is a perspective view of a razor having a shaving unit comprising the finished blade of the present invention.

FIGS. 18A-18B are schematic side views of an example atomic force microscope of the present invention.

FIG. 19 is an example image of a three dimensional representation of the ultimate tip of a razor blade produced using spatial information for a razor blade obtained by an AFM of FIGS. 18A-18B.

### DETAILED DESCRIPTION OF THE INVENTION

While thickness values of razor blade substrates, as sharpened, are generally known in the art for example in regions beyond 4 micrometers from the blade tip, obtained using interferometer, confocal instruments, or laser-based systems, robust, consistent methods to measure the blade tip geometry of a sharpened blade substrate at and very near the ultimate tip (e.g., from the ultimate tip to 2 micrometers or up to 4 micrometers) have eluded skilled artisans. It follows that coated substrates or finished blades, present similar measurement issues.

The present invention is based on the discovery that geometric values such as volume and area of a razor blade at its ultimate blade tip (e.g., in a substrate area from the ultimate tip to about 2 micrometers back from the ultimate tip) beneficially affects performance. Nothing in the prior art suggests the use or benefits of volume or area measurements of a razor blade substrate or of a coated razor blade substrate.

In particular, the present invention centers on obtaining values of volume, area, and thickness of the blade geometry at or near the ultimate blade tip (e.g., at distances of 2 micrometers or less from the ultimate tip). Importantly also, as this section near the ultimate tip is not a section where any methods capable of obtaining this type of information were available in the prior art, a novel viable method and apparatus to measure in this area, particularly closer to the ultimate tip, e.g., at 0.1 um to 1 um, to 2 um, has been demonstrated by the present invention.

This method utilizes atomic force microscopy instrumentation, a method which allows for obtaining large amounts of statistical data and which is also highly reproducible and provides the capacity of capturing the highly variable cross-sectional areas of a blade edge. In turn, this permits specific thickness, area, and volume data sets to be determined.

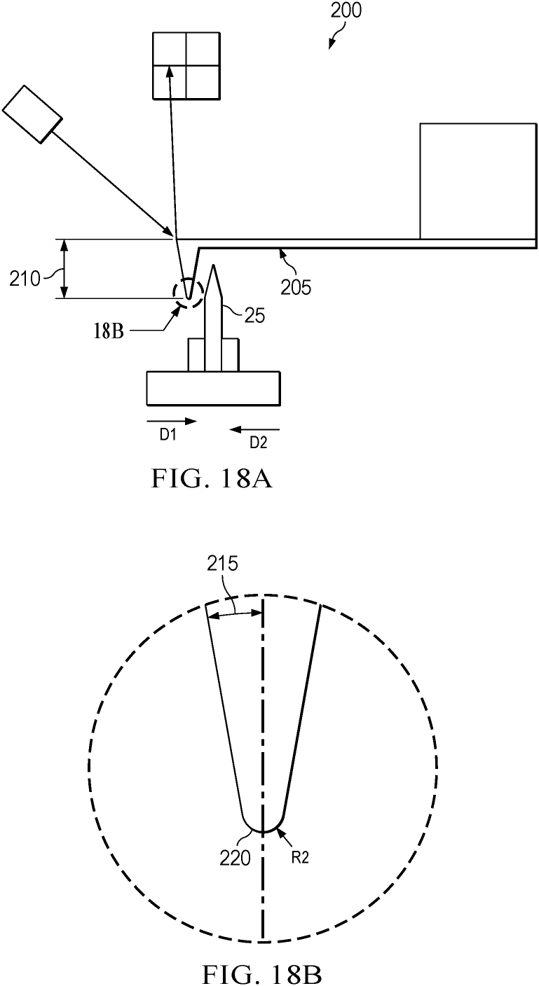

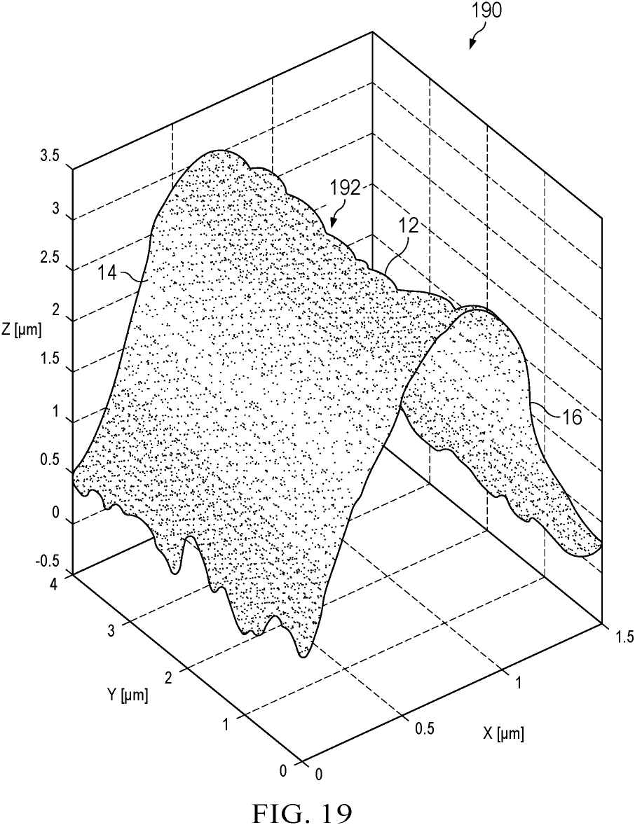

Atomic Force Microscopy is capable of obtaining dimensional values at every point in the very near tip region (e.g., at distances from the ultimate tip to a distance of 2 micrometers back from the ultimate tip) along the razor blade profile, previously unachievable in a consistent manner in the very near tip region. FIGS. 18A-18B and 19 below describe the atomic force microscope arrangement and its output, respectively.

These unique sets of data inclusive of the novel attributes of volume, area, and thickness in this region are germane to the present invention.

Obtaining and modifying these values provided the unexpected result that having a sharp blade and a small tip radius are not, in and of themselves, sufficient, as once thought, to provide optimal low cut forces, which are desired for shave performance. It was not previously appreciated that if the “wedge” itself remains “fat” in particular areas beneath the sharpened blade tip, as measured by volume or area, for instance, then the cut forces will still be high.

It has been found that lower volume values beneath the sharpened blade tip of a cutting edge (e.g., up to a distance of about 2 micrometers back from the sharpened tip) as compared to the prior art, are linked to very low cut forces with improved shave performance. The volume value as will described herein, is a novel attribute for blade measurements, which is directly tied with blade performance.

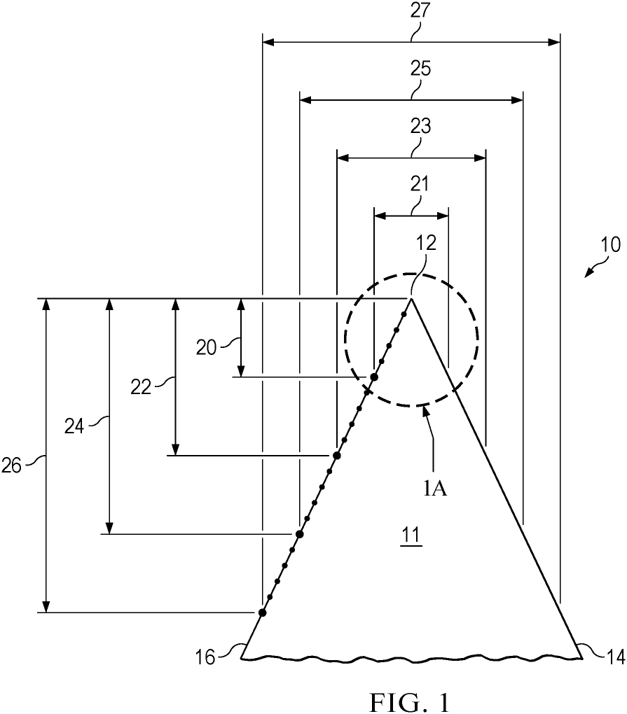

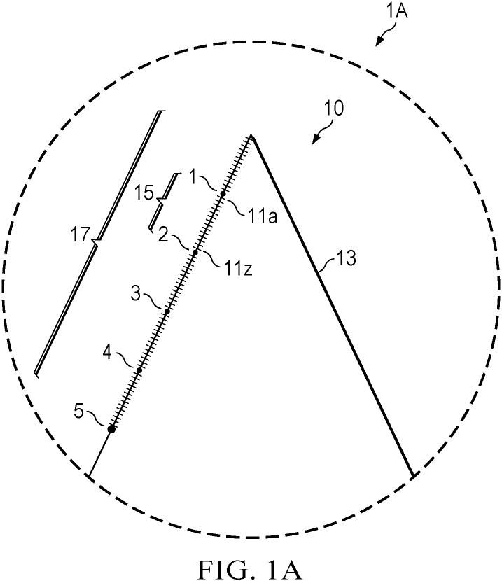

Referring now to FIG. 1, there is shown a razor blade 10. The razor blade 10 includes stainless steel body portion or substrate 11 with a wedge-shaped sharpened edge (or cutting edge) having a sharpened tip 12. Tip 12 may also be referred to as a tip portion or the ultimate tip. Tip 12 preferably has a radius of from about 100 to about 500 Angstroms (or 10 to 50 nanometers) with facets 14 and 16 on each edge that diverge from tip 12.

### Thickness

The present invention determined values of blade tip thicknesses at each 0.1 micrometer increment back from the sharpened tip 12 to 2 micrometers back from the sharpened tip 12. For instance, measurements of thickness values were taken at distances 0.1, 0.2, 0.3, 0.4, 0.5, 0.6, 0.7, 0.8, 0.9, 1.0, 1.1., 1.2, 1.3, 1.4, 1.5, 1.6, 1.7, 1.8, 1.9 and 2.0 micrometers back from the sharpened tip 12.

Four exemplary distances are highlighted in FIG. 1, notably 0.5, 1.0, 1.5, and 2.0 micrometers back from the sharpened blade tip 12.

The substrate 11 has a thickness or width 21 of about 0.35 micrometers measured at a distance 20 of 0.5 micrometers from the blade tip 12.

The substrate 11 has a thickness 23 of about 0.55 micrometers measured at a distance 22 of 1.0 micrometer from the blade tip 12.

The substrate 11 has a thickness 25 of about 0.75 micrometers measured at a distance 24 of 1.5 micrometers from the blade tip 12.

The substrate 11 has a thickness 27 of about 0.95 micrometers measured at a distance 26 of 2 micrometers from the blade tip 12.

Table 1 below outlines desired thickness values contemplated in the present invention blades for distances back from the blade tip. The units for distance and thickness are micrometers. In addition, Table 1 lists corresponding thickness value ranges measured for prior art razor blade edges.

TABLE 1

| Distance from Blade Tip | Blade Tip Thickness Present Invention | Blade Tip Thickness Prior Art |
|---|---|---|
| 0.1 | 0.135-0.138 | 0.151-0.163 |
| 0.2 | 0.199-0.203 | 0.227-0.239 |
| 0.3 | 0.256-0.259 | 0.290-0.309 |
| 0.4 | 0.307-0.308 | 0.346-0.368 |
| 0.5 | 0.351-0.355 | 0.397-0.422 |
| 0.6 | 0.392-0.398 | 0.446-0.474 |
| 0.7 | 0.431-0.439 | 0.493-0.523 |
| 0.8 | 0.470-0.479 | 0.539-0.572 |
| 0.9 | 0.509-0.519 | 0.582-0.621 |
| 1.0 | 0.547-0.557 | 0.624-0.669 |
| 1.1 | 0.586-0.596 | 0.665-0.716 |
| 1.2 | 0.625-0.634 | 0.706-0.764 |
| 1.3 | 0.664-0.673 | 0.747-0.810 |
| 1.4 | 0.705-0.712 | 0.787-0.857 |
| 1.5 | 0.747-0.751 | 0.828-0.903 |
| 1.6 | 0.791-0.793 | 0.868-0.950 |
| 1.7 | 0.832-0.835 | 0.909-0.996 |
| 1.8 | 0.873-0.881 | 0.951-1.043 |
| 1.9 | 0.916-0.928 | 0.993-1.089 |
| 2.0 | 0.957-0.977 | 1.036-1.136 |

The thickness values captured at these distances provide a framework for improved shaving by providing a balance between edge strength and low cutting force or sharpness. A substrate having greater thicknesses from the blade tip to 2 micrometers back will have a higher cutting force leading to an increased tug and pull and increased discomfort for the user during shaving.

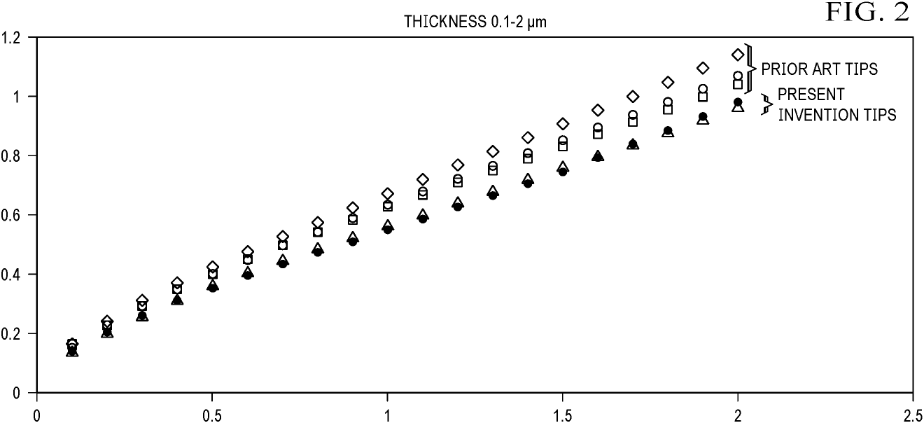

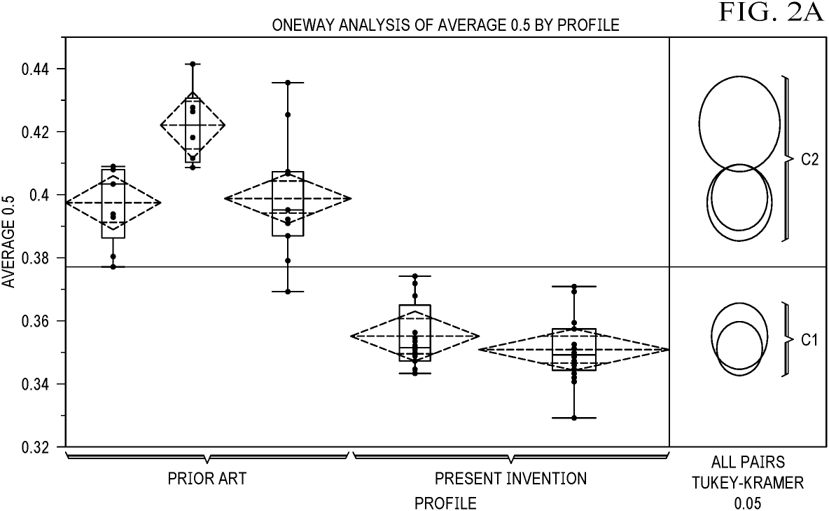

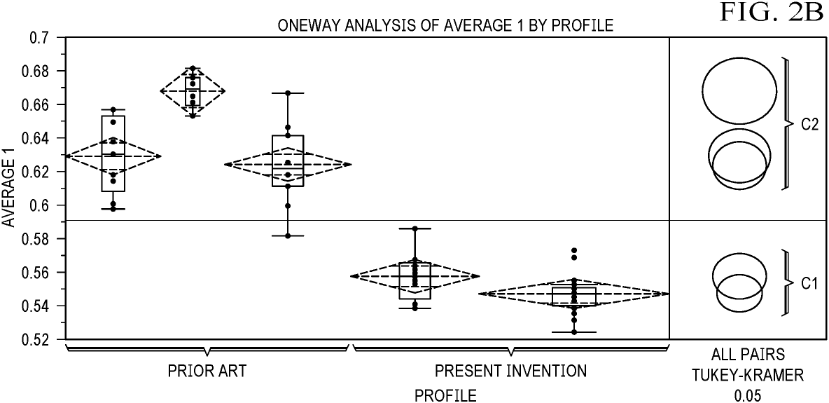

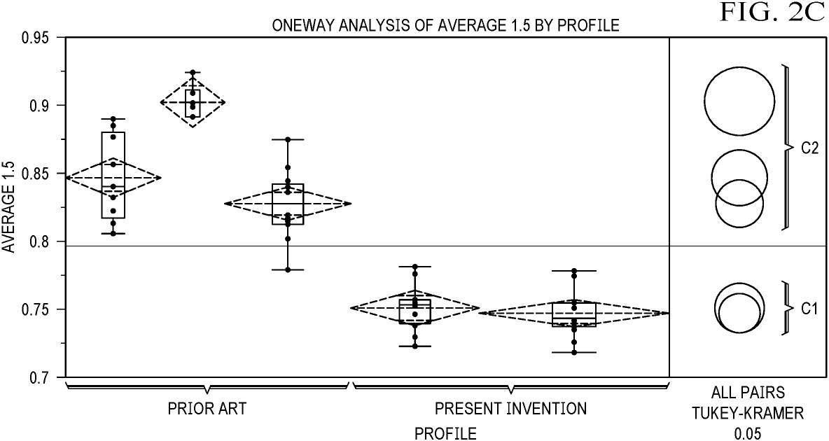

FIG. 2 is a graph of the thickness values of Table 1 depicting the novel thickness values for the present invention razor blade tips and the thickness value ranges of the prior art razor blade tips.

As can be seen from the graph in FIG. 2, the present invention blade tip thickness values are lower throughout (e.g., at each point) vis-à-vis the prior art. This thickness differentiation provides the advantage necessary and a direct link to improved shaving performance.

Referring to FIGS. 2A-2D, charts with thickness data drawn from the tables and graph above, are shown in accordance with the present invention. Using a one-way analysis of variance (e.g., a Tukey Kramer test, abbreviated one-way ANOVA) technique, dimensions of the present invention blades were compared to the prior art blades to determine if a significant difference exists (e.g., a statistical difference). FIG. 2A represents the data at a distance of 0.5 micrometers back from the blade tip. FIG. 2B represents data at a distance of 1 micrometer back from the blade tip. FIG. 2C represents data at a distance of 1.5 micrometers back from the blade tip. FIG. 2D represents data at a distance of 2 micrometers back from the blade tip.

The Tukey Kramer test used in the present invention is a statistical analysis method for hypothesis testing, based on standard and well-known ANOVA techniques. The circles on the right side of the graphs in FIGS. 2A-2D are called comparison circles, a visual representation of the group means comparison. They are a graphical representation of the least significant difference (LSD) in a multiple comparison test. Each pair of group means can be visually compared by examining the intersection of the comparison circles. The outside angle of intersection indicates whether the group means are significantly different. Circles for means that are significantly different either do not intersect, or intersect slightly, so that the outside angle of intersection is less than 90 degrees. If the circles intersect by an angle of more than 90 degrees, or if they are nested, the means are generally not significantly different.

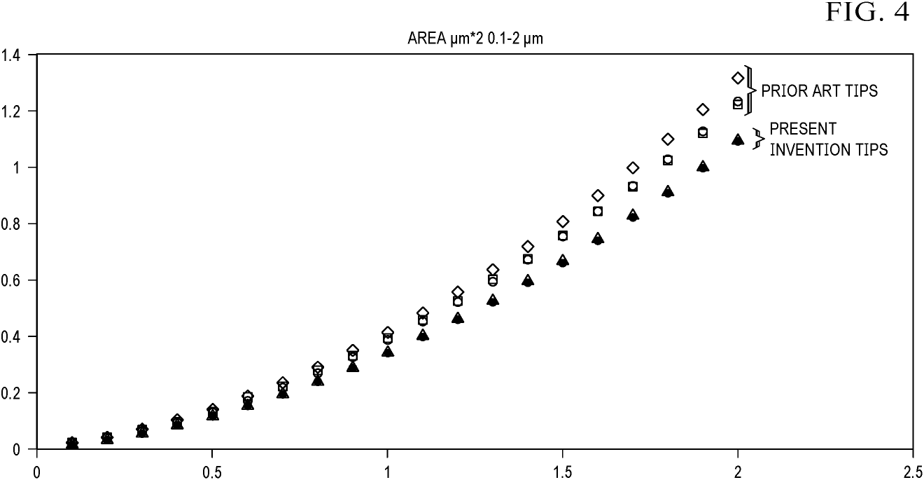

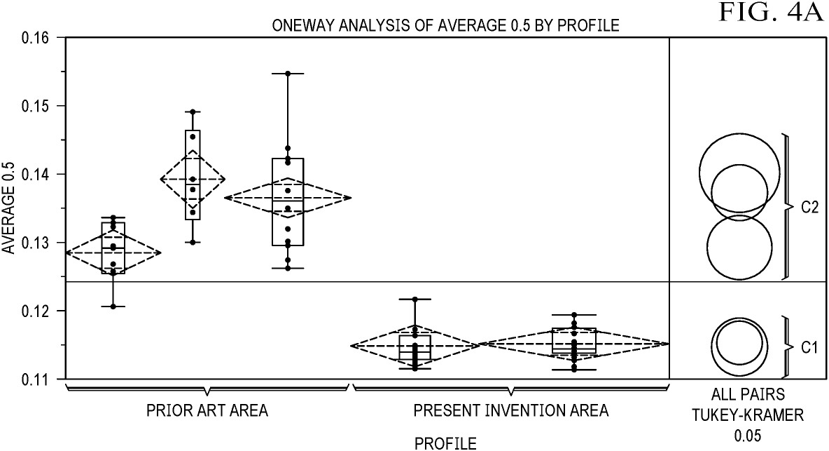

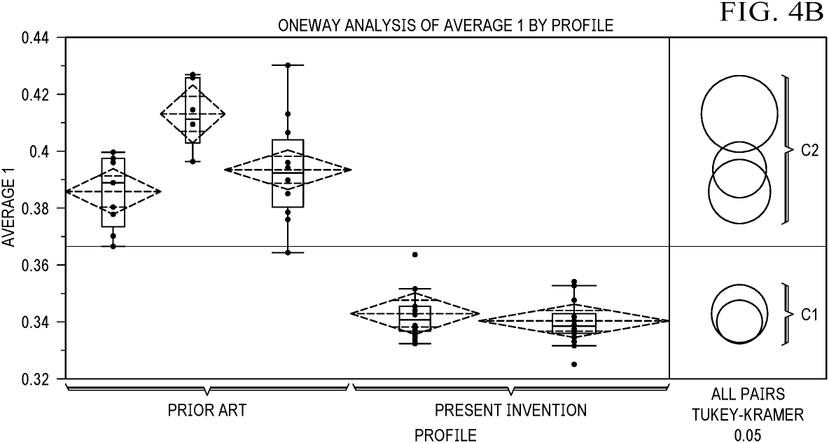

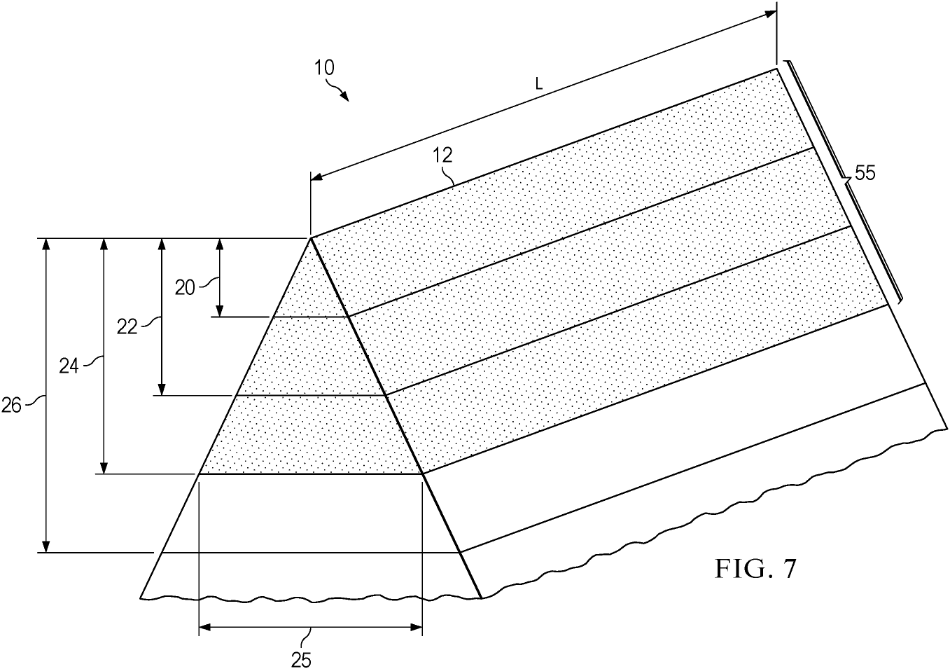

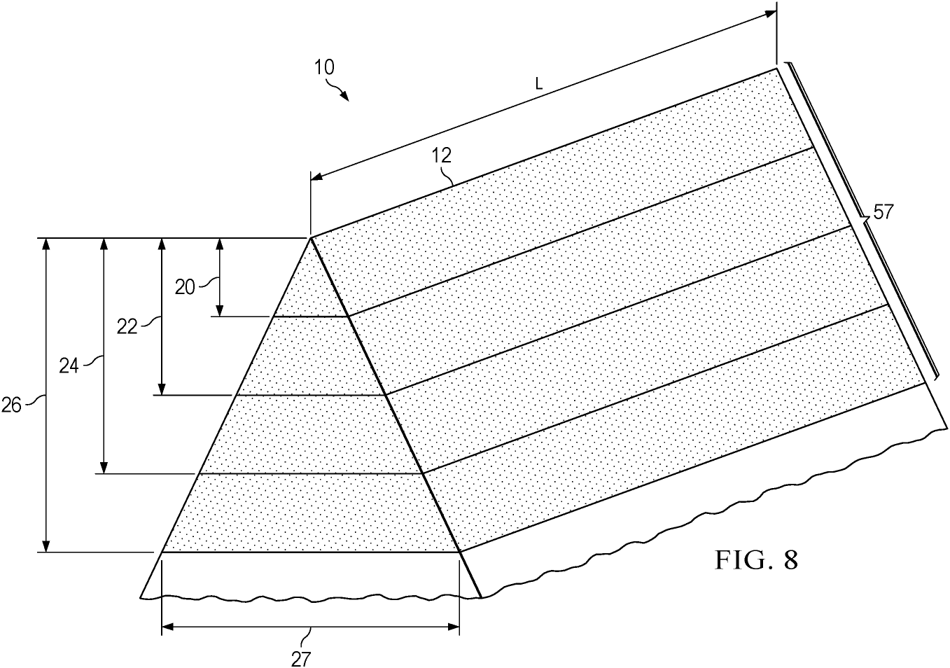

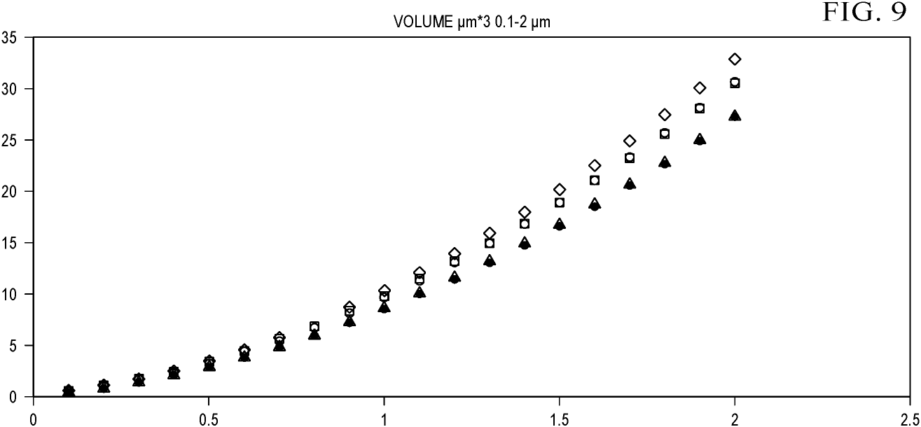

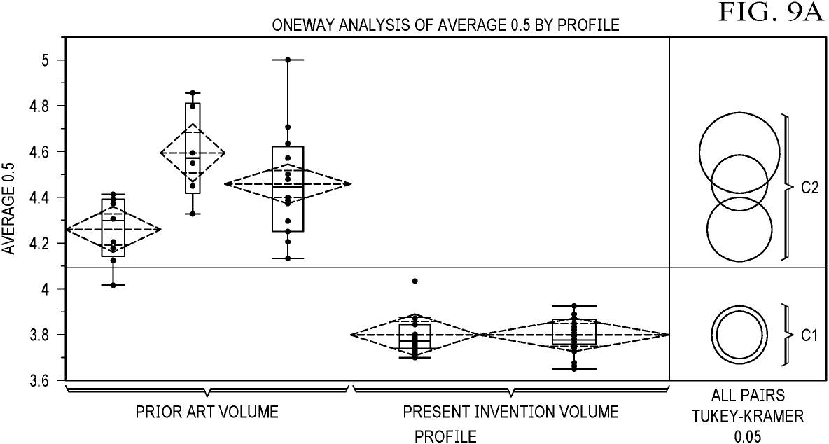

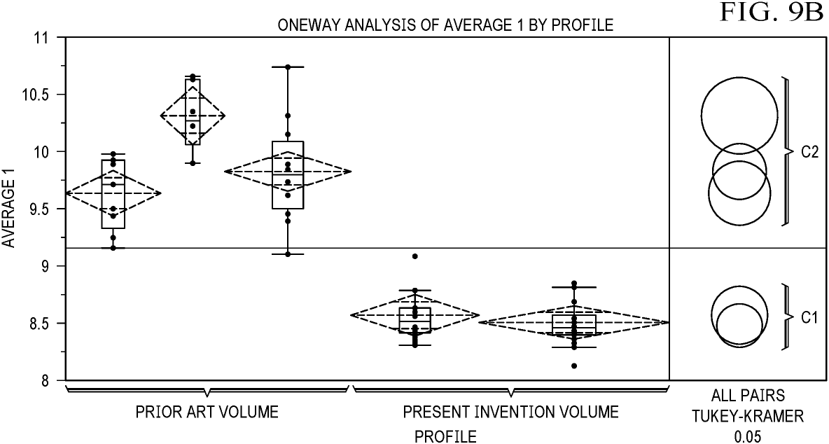

As can be seen in each of the charts in FIGS. 2A-2D, the circles C1 of FIGS. 2A-2D for the present invention do not intersect the circles C2 of the prior art. Thus, each of three prior art blades have thickness dimensions that are unambiguously statistically different than the present invention blades at each of the distances back from the tip. All other charts described and shown herein (e.g., FIGS. 4A-4D, FIGS. 9A-9D), illustrate the same lack of overlap in comparison circles between the prior art circles C1 and the present invention circles C2 and thus represent a significant difference over the prior art.

The charts in the above-mentioned figures also graphically represent the significant differences of the present invention over the prior art using diamond shaped elements and box plots, known analysis tools. The diamond shaped elements are Mean Diamonds where the top and bottom of each diamond represent the (1-alpha)x100 confidence interval for each group. Typically mean diamonds shown span 95% confidence intervals for the means. The mean line across the middle of each diamond represents the group mean. Overlap marks appear as lines above and below the group mean. For groups with equal sample sizes, overlapping marks indicate that the two-group means are not significantly different at the given confidence level.

The Box Plot elements in the graphs of the present invention provide a compact view of a distribution of values and show outlier or quantile box plots. The box extends from the 25th percentile to the 75th percentile where the distance between the 75th and 25th percentiles is the interquartile range (IQR). The median is marked within the box. The lines extending the farthest out from the mean are referred to as the whiskers, representing outermost data points.

In each of the graphs herein (e.g., FIGS. 2A-2D, 4A-4D, 9A-9D), the diamond elements and the box plots, as well as the Tukey Kramer analysis graphically indicate the significant differences of the present invention over the prior art.

### Interpolation

Importantly, the graphs indicate an interpolation of data in the present invention. While the Tables herein (e.g., Table 1) depict geometric values at discrete distances starting from 0.1um and ending at 2.0 micrometer at 0.1 micrometer increments back from the blade tip, it is appreciated that an interpolation exists between the listed increment distances back from the blade tip and the respective values for thickness and other geometries such as area and volume. For instance, as just one non-limiting example, between points 0.1 micrometers and 0.2 micrometers back from the blade tip (e.g., greater than 0.1 micrometers up to 0.19999 micrometers), there is an assumed connection surface between those points on the razor blade profile, a surface which is continuous and generally smooth, such that even though measurement values are not specifically listed in the Tables for distances back from tip 12 between greater than 0.1um and up to 0.19999um, these values are understood to be generally conformal between the values for the 0.1um and 0.2um. This interpolation is visible and generalized in FIG. 1A which depicts the close-up view 1A of FIG. 1. In FIG. 1A, point 0 is at the blade tip 12, point 1 is 0.1 micrometers back from the sharpened blade tip 12, point 2 is 0.2 micrometers back from the sharpened blade tip 12, point 3 is 0.3 micrometers back from the sharpened blade tip 12, point 4 is 0.4 micrometers back from the sharpened blade tip (or ultimate tip) 12, and point 5 is 0.5 micrometers back from the sharpened blade tip 12. As can be seen, between point 1 and point 2, there are discrete points that range between point 11a, a point greater than 0.1 micrometer at point 1 and up to a point 11z, a point 0.19999 micrometer just before point 2 at 0.2 micrometers. This interpolation is also clearly illustrated in the graph depicted in FIG. 2, as well as graphs of FIGS. 4 and 9. As can be seen in FIGS. 1 and 1A and the graphs of FIG. 2, (and as will be discussed below FIGS. 4 and 9), the blade edge profile 13, which is present on either side of the tip 12, does not vary in an exaggerated manner in between points 11a and 11z. Rather there is a connection surface 15 formed between these points and it follows that there is a similar interpolation and connection surface formed throughout the profile 13 between points 0 and 2. Indeed, the connection surface 15 essentially extends point to point to form a conformal surface 17 linking all the points along the blade edge profile 13 as shown in FIG. 1A.

Moreover, as can be seen in the graphs of the present invention, surface 17 in the near tip region was discovered to be one having a non-linear relationship. This was in unexpected contrast to the linear relationship that is found in surfaces of razor blade profiles at distances beyond the near tip (e.g., 40 micrometers or greater from the ultimate tip).

It was determined that geometries (e.g., volume, area, thickness) in this near tip region (e.g., from the ultimate tip to 2 micrometers back from the ultimate tip) have an unusually strong leverage on cut forces relative to geometries farther back from the tip (e.g., beyond 4 micrometers). The cut forces of the present invention blades are detailed below.

### Area

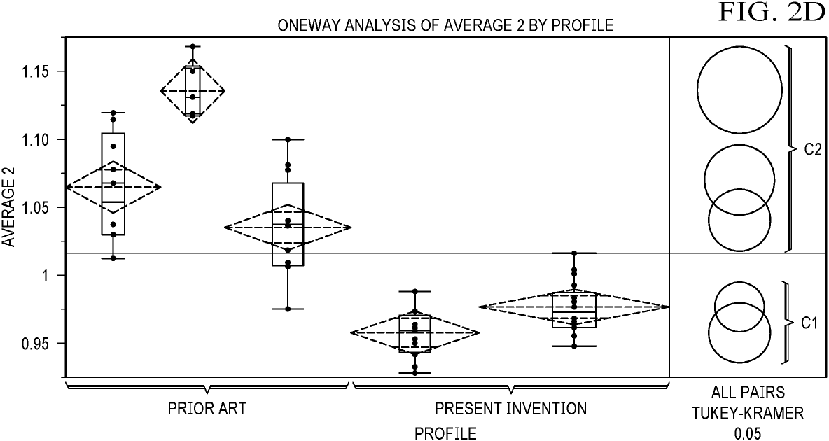

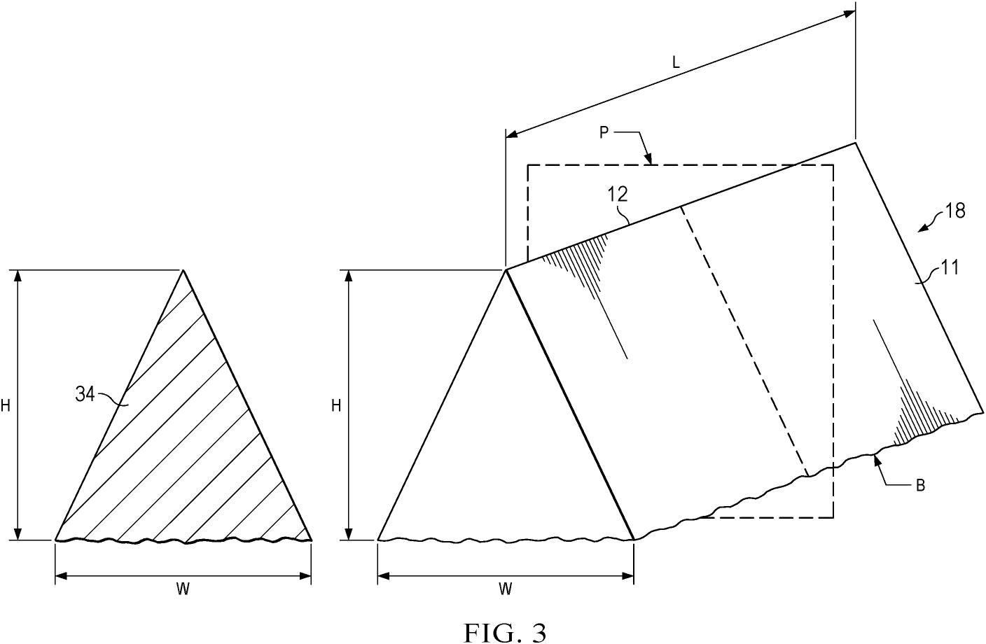

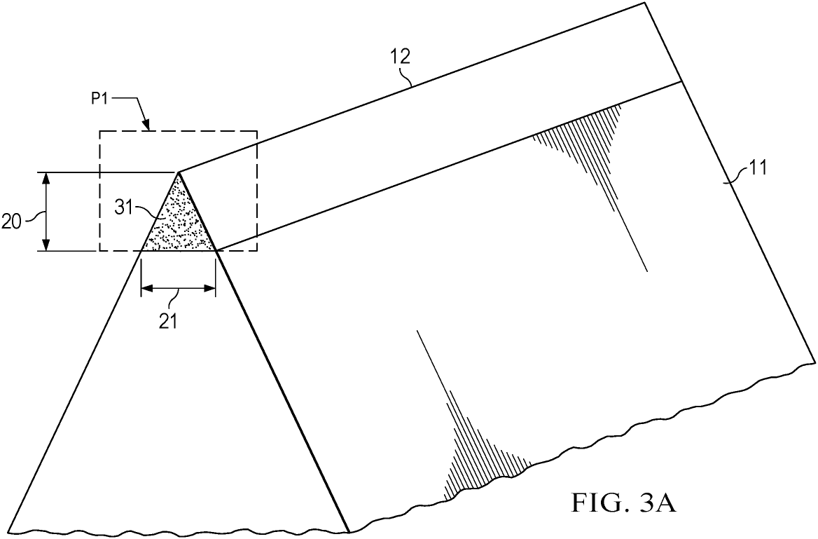

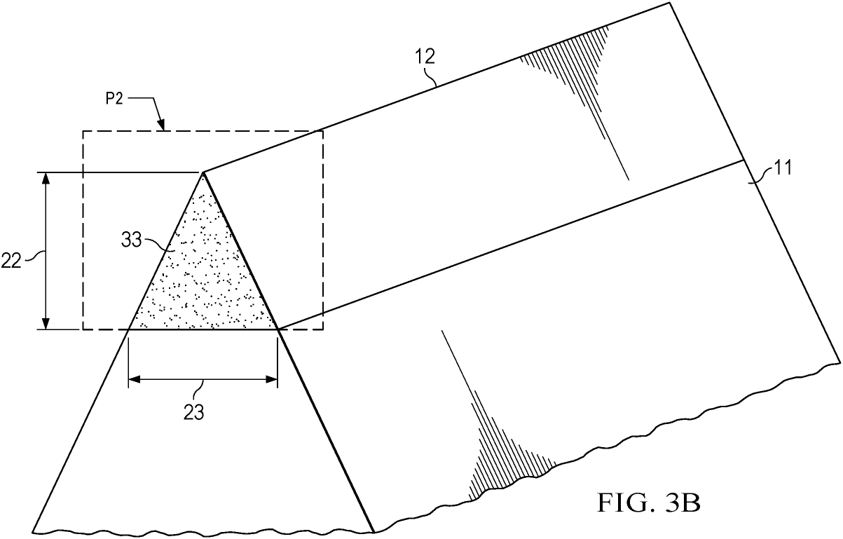

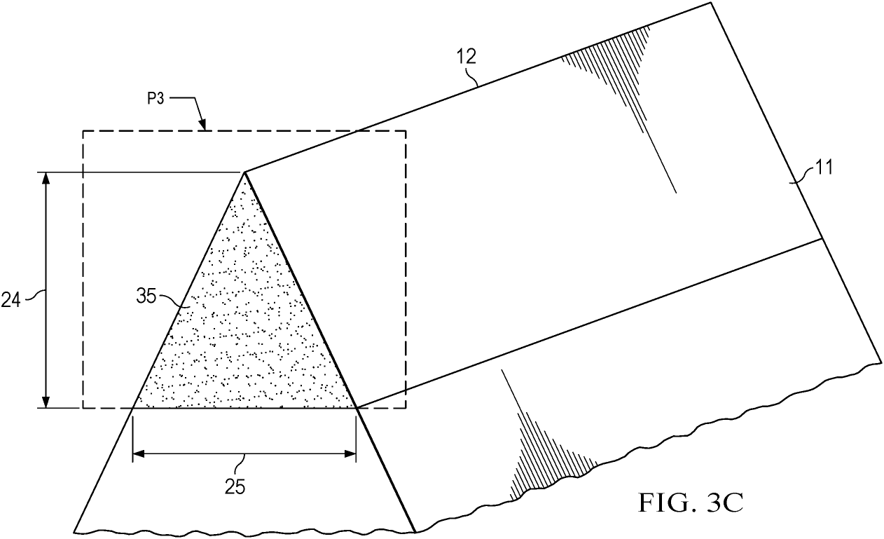

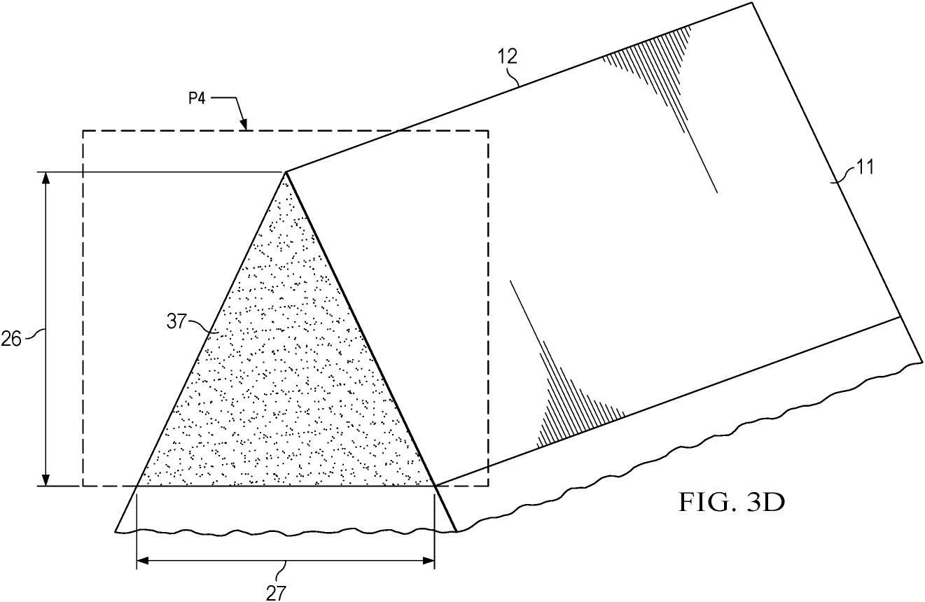

Referring now to FIG. 3, there is shown the razor blade 10 of FIG. 1 where the wedge-shaped sharpened edge (or cutting edge) of substrate 11 is shown in a three-dimensional view such that it resembles a triangular prism 18. A plane P taken along a plane perpendicular to the base B of the wedge-shaped triangular prism 18 of blade substrate 11 creates a triangular cross-section 34. This horizontal cross-section has an area A determined by the height H (distance back from ultimate tip 12) and the thickness or width W or thickness 18 of the substrate. As shown in FIGS. 3A-3D, several vertical cross-sectional areas (e.g., or “slices”) 31, 33, 35, and 37 are taken by vertical cross-sections formed by planes P1, P2, P3, and P4 and are measured along the heights or distances 20, 22, 24, and 26 from the tip 12 of the substrate 11 starting from one end to the other. The length L of the substrate 11 is generally about 25 micrometers.

The width W or thickness of the substrate is generally represented by the values of the present invention listed in Table 1. For instance, plane P1 formed at a distance 20 of 0.5 micrometers back from the blade tip 12 has a thickness value of about 0.35 micrometers. Plane P2 is formed at a distance 22 of 1.0 micrometers back from the blade tip 12, plane P3 is formed at a distance 24 of 1.5 micrometers back from the blade tip 12 and plane P4 is formed at a distance 26 of 2.0 micrometers back from the blade tip 12.

The substrate 11 of the present invention has an area 31 of between about 0.115 square micrometers to about 0.128 square micrometers measured at a distance 20 of 0.5 micrometers from the blade tip 12.

The substrate 11 of the present invention has an area 33 of between about 0.340 square micrometers to about 0.343 square micrometers measured at a distance 22 of 1.0 micrometers from the blade tip 12.

The substrate 11 of the present invention has an area 35 of between about 0.663 square micrometers to about 0.70 square micrometers measured at a distance 24 of 1.5 micrometers from the blade tip 12.

The substrate 11 of the present invention has an area 37 of between about 1.09 square micrometers to about 1.1 square micrometers measured at a distance 26 of 2 micrometers from the blade tip 12.

Table 2 below outlines cross-sectional area values contemplated in the present invention blades for distances back from the blade tip. The units for distance are micrometers and the unites for area are square micrometers. In addition, Table 2 lists corresponding area value ranges measured for prior art razor blade edges.

TABLE 2

| Distance from Blade Tip | Blade Tip AREA Present Invention | Blade Tip AREA Prior Art |
|---|---|---|
| 0.1 | 0.015-0.016 | 0.016-0.023 |
| 0.2 | 0.032-0.033 | 0.035-0.042 |
| 0.3 | 0.054-0.055 | 0.060-0.068 |
| 0.4 | 0.082-0.083 | 0.091-0.100 |
| 0.5 | 0.115-0.116 | 0.129-0.139 |
| 0.6 | 0.152-0.153 | 0.171-0.184 |
| 0.7 | 0.193-0.194 | 0.217-0.234 |
| 0.8 | 0.238-0.239 | 0.269-0.289 |
| 0.9 | 0.287-0.289 | 0.325-0.348 |
| 1.0 | 0.340-0.343 | 0.386-0.413 |
| 1.1 | 0.397-0.400 | 0.451-0.482 |
| 1.2 | 0.457-0.462 | 0.520-0.556 |
| 1.3 | 0.522-0.527 | 0.594-0.635 |
| 1.4 | 0.590-0.596 | 0.672-0.718 |
| 1.5 | 0.663-0.669 | 0.754-0.806 |
| 1.6 | 0.740-0.746 | 0.841-0.899 |
| 1.7 | 0.821-0.827 | 0.930-0.996 |
| 1.8 | 0.907-0.912 | 1.023-1.098 |
| 1.9 | 0.998-1.002 | 1.120-1.204 |
| 2.0 | 1.093-1.095 | 1.221-1.316 |

As can be seen from the graph in FIG. 4, the present invention blade tip area values are lower throughout (e.g., at each point) vis-à-vis the prior art areas. This area differentiation provides the advantage necessary and a direct link to improved shaving performance. This is because having a sharp blade (e.g., with a small tip radius) has been surprisingly determined to be not solely adequate to provide the best cuts, closeness, and efficiency. If the three-dimensional wedge-shaped substrate is too fat, as measured by area, and particularly at the ultimate tip, then the cut force of the cutting edge will still be high, producing a less than optimal shave.

Referring to FIGS. 4A-4D, charts with cross-sectional area data drawn from the Table 2 and graph in FIG. 4 above, are shown in accordance with the present invention. Using a one-way analysis of variance (abbreviated one-way ANOVA) technique, dimensions of the present invention blades were compared to the prior art blades to determine if a significant difference exists (e.g., a statistical difference). FIG. 4A represents the data at a distance of 0.5 micrometers back from the blade tip. FIG. 4B represents data at a distance of 1 micrometer back from the blade tip. FIG. 4C represents data at a distance of 1.5 micrometers back from the blade tip. FIG. 4D represents data at a distance of 2 micrometers back from the blade tip. As can be seen in each of the charts in FIGS. 4A-4D, each of the three prior art blades have cross-sectional area dimensions that are clearly statistically greater than the present invention blades at each of the distances back from the tip.

### Volume

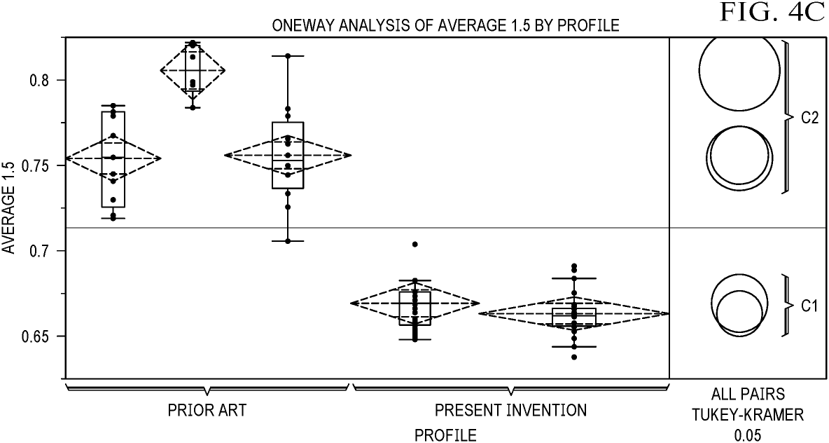

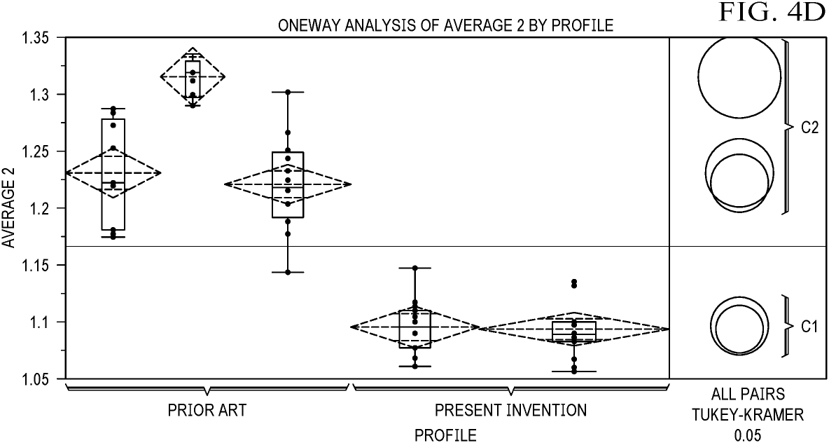

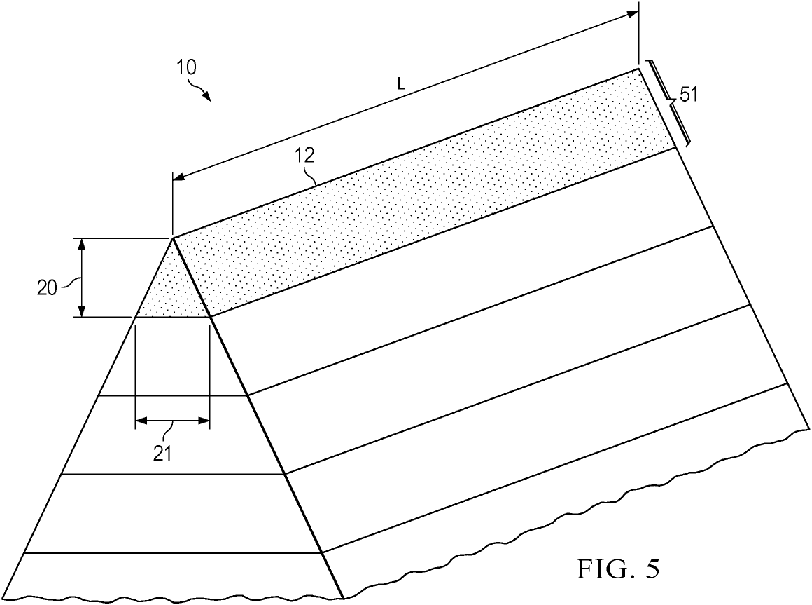

Referring now to FIGS. 5-8, there is shown the razor blade 10 of FIGS. 1, 3, 3A-3D, where the wedge-shaped sharpened edge (or cutting edge) of substrate 11 is shown in a three-dimensional view such that it resembles a triangular prism 18. In FIG. 5, a first volume 51 is determined at a distance 20 of 0.5 micrometers back from the sharpened blade tip (or ultimate tip) 12 by utilizing the value of area 31 taken at 0.5 micrometers and multiplying by the length L, effectively a summation of all the “triangular” cross-sectional areas along the length of the blade substrate. The length L is generally about 25 micrometers. Taken with the area 31 of about 0.115 square micrometers at the same distance, the novel volume 51 of FIG. 5 of the present invention is determined to generally range from about 2.863 cubic micrometers to about 2.875 cubic micrometers. Similar calculations are determined for the present invention blade volumes in FIGS. 6-8.

In FIG. 6 at a distance 22 of 1 micrometer back from the tip, cross-sectional area 33 of FIG. 3B of between about 0.34 square micrometers to about 0.38 square micrometers at the same distance 22 provides a volume 53 of about 8.485 to about 8.553 cubic micrometers.

In FIG. 7 at distance 24 of 1.5 micrometers back from the tip, cross-sectional area 35 of FIG. 3C of between about 0.66 square micrometers to about 0.75 square micrometers at distance 24 provides a volume 55 of about 16.543 cubic micrometers to about 16.692 cubic micrometers.

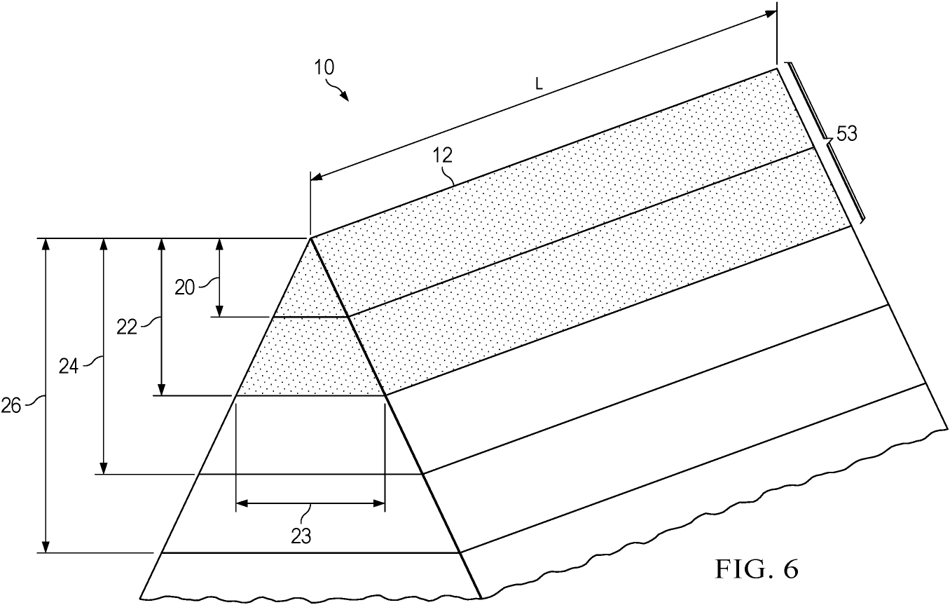

In FIG. 8 at distance 26 of 2 micrometers back from the tip, area 37 of FIG. 3D of between about 1.09 square micrometers to about 1.2 square micrometers measured at a distance 26 of 2 micrometers from the blade tip 12 provides a volume 57 of about 27.274 cubic micrometers to about 27.328 cubic micrometers.

Table 3 below outlines desired volume values contemplated in the present invention blades for distances back from the blade tip. The units for distance are micrometers and the units for volume are cubic micrometers. In addition, Table 3 lists corresponding area value ranges measured for prior art razor blade edges.

TABLE 3

| Distance from Blade Tip | Blade Tip VOLUME Ranges Present Invention Blades | Blade Tip VOLUME Ranges Prior Art Blades |
|---|---|---|
| 0.1 | 0.379-0.400 | 0.399-0.580 |
| 0.2 | 0.793-0.799 | 0.861-1.058 |
| 0.3 | 1.353-1.361 | 1.496-1.695 |
| 0.4 | 2.046-2.059 | 2.282-2.494 |
| 0.5 | 2.863-2.875 | 3.406-3.477 |
| 0.6 | 3.797-3.798 | 4.256-4.592 |
| 0.7 | 4.822-4.836 | 5.426-5.835 |
| 0.8 | 0.5.947-5.975 | 6.713-7.202 |
| 0.9 | 7.168-7.214 | 8.114-8.693 |
| 1.0 | 8.485-8.553 | 9.625-10.303 |
| 1.1 | 9.897-9.988 | 11.247-12.029 |
| 1.2 | 11.409-11.521 | 12.979-13.872 |
| 1.3 | 13.019-13.147 | 14.819-15.833 |
| 1.4 | 14.729-14.872 | 16.763-17.914 |
| 1.5 | 16.543-16.692 | 18.819-20.109 |
| 1.6 | 18.466-18.613 | 20.982-22.422 |
| 1.7 | 20.496-20.636 | 23.194-24.850 |
| 1.8 | 22.639-22.761 | 25.514-27.393 |
| 1.9 | 24.897-24.989 | 27.942-30.049 |
| 2.0 | 27.274-27.328 | 30.473-32.828 |

As can be seen from the graph in FIG. 9 which plots a subset of the points of Table 3 the present invention blade tip volume values are lower throughout (e.g., at each point) vis-à-vis the prior art volumes.

Referring to FIGS. 9A-9D, charts with volume data drawn from the Table 3 and graph in FIG. 9 above, are shown in accordance with the present invention. Using a one-way analysis of variance (abbreviated one-way ANOVA) technique, dimensions of the present invention blades were compared to the prior art blades to determine if a significant difference exists (e.g., a statistical difference). FIG. 9A represents the data at a distance of 0.5 micrometers back from the blade tip. FIG. 9B represents data at a distance of 1 micrometer back from the blade tip. FIG. 9C represents data at a distance of 1.5 micrometers back from the blade tip. FIG. 9D represents data at a distance of 2 micrometers back from the blade tip. As can be seen in each of the charts in FIGS. 9A-9D, each of the three prior art blades have volume dimensions that are clearly statistically greater than the present invention blades at each of the distances back from the tip.

This volume differentiation provides the advantage necessary and a direct link to improved shaving performance. This is because having a sharp blade (e.g., with a small tip radius) has been surprisingly determined not to be sufficient alone to provide the best performance for cuts, closeness, and efficiency. If the wedge-shaped substrate is too large, as measured by volume, and particularly at the ultimate tip under 2 micrometers, then the cut force of the cutting edge will still be high, producing a less than optimal shave.

The total desired volume of the present invention blade substrate at the near tip is in the range of 27.3 cubic micrometers. Having a three-dimensional value for volume in the desired range provides a novel feasible framework for improved shaving, providing an effective balance between edge strength and low cutting force or sharpness. A substrate having too small of a volume may have less strength leading to ultimate edge failure. A substrate having larger volumes may have a higher cutting force leading to an increased tug and pull and increased discomfort for the user during shaving.

As noted above, the novelty of the present invention is encompassed by first, the ability to measure new geometries of blade substrates 11 from the tip 12 at distances from 0 to 2 micrometers back from the tip, consistently, a process not robust in the prior art. This ability to capture these newly appreciated dimensions (e.g., volume) in this region is executed through the use of Atomic Force Microscopy instrument described below with regard to FIGS. 18A-18B and 19.

Second, obtaining novel dimensional values consistently at the tip at distances from 0 to 2 micrometers back, allows the blade developer to test and subsequently carefully craft the tip (e.g., at distances of 0 to 2 micrometers back), to produce the improved blade performance. The measurements of volume and area are not contemplated in the prior art and surprisingly, were found, even with a very sharp blade (e.g., thin, small thickness) to serve as superb data to hone and craft improved blade tips (e.g., reduce cut force) even further than previously thought possible.

### Substrate Material

The substrate 11 may be any material but is desirably a stainless steel of any type to facilitate producing an appropriately sharpened edge. The stainless steel of the present invention may be a martensitic stainless steel. This steel may comprise about 0.35% to about 0.6% Carbon (C) and about 13% to about 14% Chromium (Cr). The martensitic steel may desirably comprise about 1.1% to about 1.5% Molybdenum (Mo).

Additionally, the martensitic stainless steel may contain smaller, more finely distributed carbides, but with similar overall carbon weight percent. A fine carbide substrate provides for a harder and more brittle after-hardening substrates, and enables the making of a thinner, stronger edge. An example of such a substrate material is a martensitic stainless steel with a finer average carbide size with a carbide density of at least about 200 carbides per square micrometer, more preferably at least about 300 carbides per square micrometer and most preferably at least about 400 carbides or more per 100 square micrometers as determined by optical microscopic cross-section.

### Substrate Values Beyond 2 Micrometers

As discussed above, facets 14 and 16 of FIG. 1 of the wedge-shaped edge of blade 10 diverge from tip 12. In accordance with an alternate preferred embodiment of the present invention, dimensions for distances further back from the blade tip 12 (e.g., beyond 2 micrometers) are contemplated in the present invention. For instance, U.S. Pat. No. 9,073,321, assigned to the Assignee hereof, and incorporated by reference provides thickness values for distances at 4, 8, and 16 micrometers back from the blade tip 12. The novel dimensional values described supra, measured using Atomic Force Microscopy as described herein, can be combined with values determined in the prior art which are measured by interferometer or confocal instruments to produce a blade edge.

For instance, the dimensional values (e.g., of Tables 1-3) of the present invention, when combined with the thickness values of U.S. Pat. No. 9,079,321, provide an alternate embodiment of the present invention, for a novel razor blade tip.

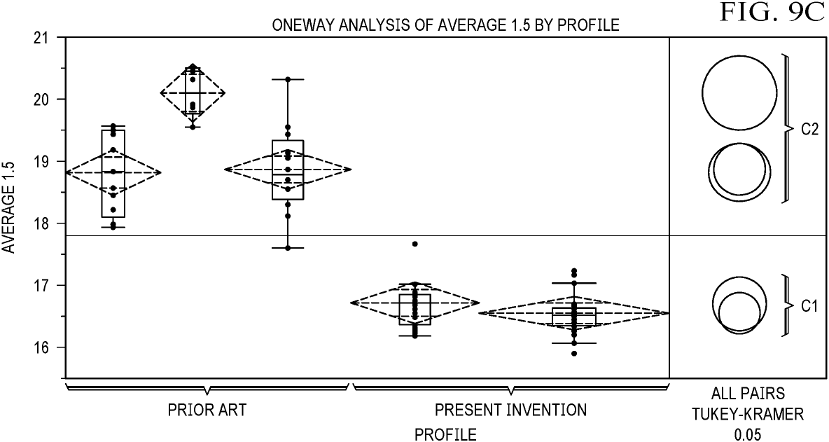

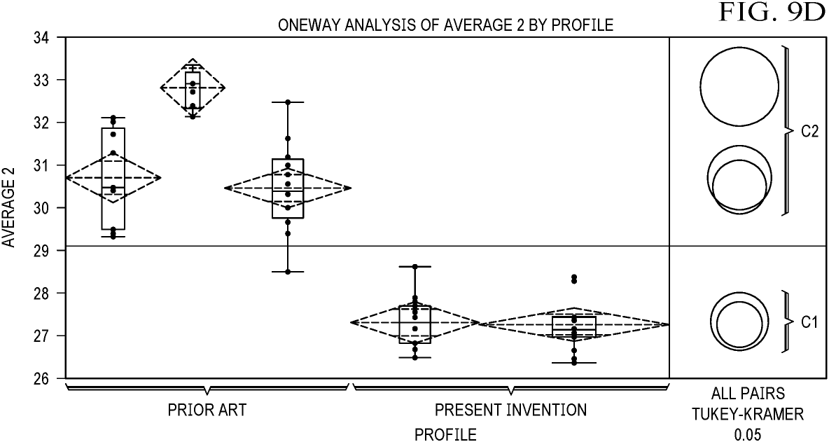

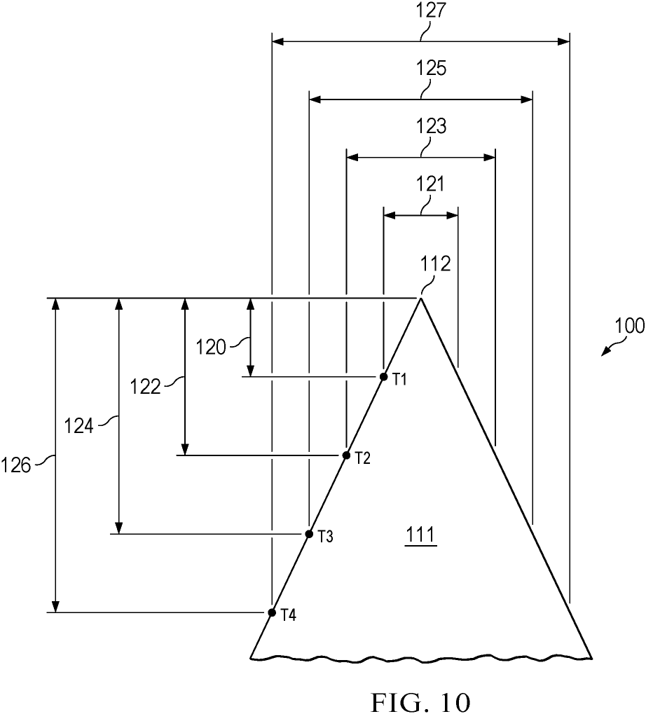

In one alternate embodiment shown in FIG. 10, a substrate 111 having a cutting edge with a sharpened tip 112, comprises a thickness 121 measured at a distance 120 of 1 micrometer back from the tip 112 ranging from about 0.547 micrometers to about 0.557 micrometers, a thickness 123 measured at a distance 122 of 2 micrometers from the tip 112 of about 0.957 micrometers to about 0.977 micrometers, a thickness 125 measured at a distance 124 of 3 microns from the tip ranging from about 0.90 micrometers to about 1.20 micrometers, and a thickness 127 measured at a distance 126 of 4 microns from the tip of about 1.20 micrometers to about 1.6 micrometers. These values are obtained using Atomic Force Microscope instrumentation.

### Tip Radius

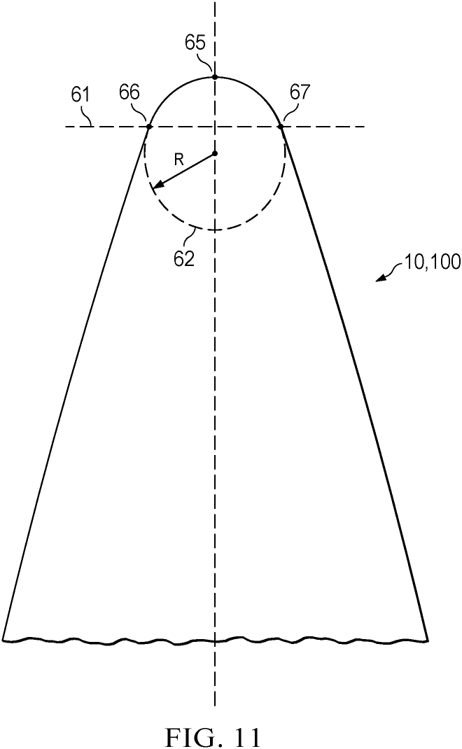

Blade tip 12 of FIG. 1 of blade 10 (uncoated substrate) preferably has a radius of from 100 to 500 Angstroms. As shown in FIG. 11, the tip radius is determined by first drawing a line 60 bisecting the blade 10 in half. Where line 60 bisects blade 10, a first point 65 is drawn. A second line 61 is drawn perpendicular to line 60 at a distance of 225 Angstroms or 0.025 micrometers from point 65. Where line 61 bisects coated blade 13 two additional points 66 and 67 are drawn. A circle 62 is then constructed from points 65, 66 and 67. The radius R of circle 62 is the tip radius for blade 10.

The value of the tip radius of the substrate of the present invention ranges from about 100 to about 500 Angstroms. The tip radius can also be determined in the same manner for a coated blade of FIG. 10. The value of the tip radius of the coated blade 100 is about 100 to 500 Angstroms.

### Included Angle

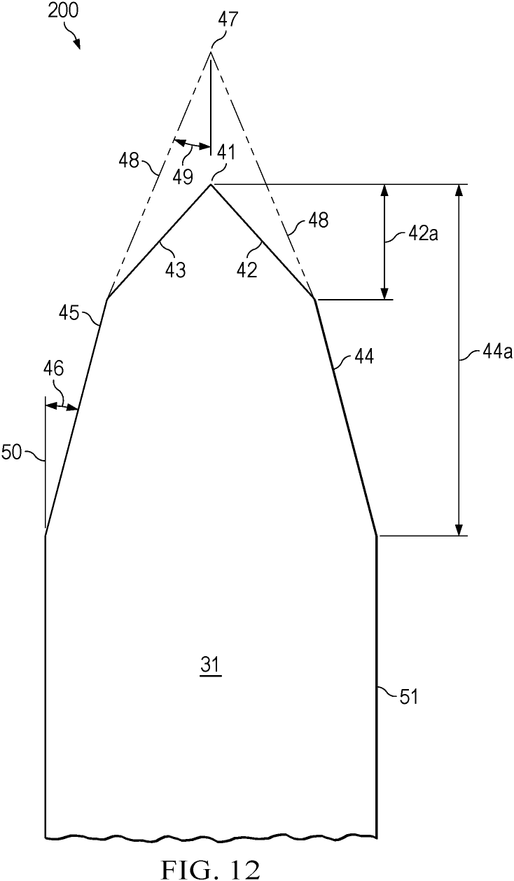

As discussed above, facets 14 and 16 of FIG. 1 of the wedge-shaped edge of blade 10 diverge from tip 12. In accordance with an alternate preferred embodiment of the present invention, each edge of the wedge-shaped edge of the razor blade of the present invention may also include an additional facet. Turning to FIG. 12, blade 200 of the present invention is shown having a substrate 31 with two facets on each side or edge. First facets 44, 45 on either edge may generally initially be formed and by known methods (e.g., grinding). Similarly, second facets 42, 43 may subsequently be formed such that they define the final blade tip 41 (e.g., the facets 42, 43 diverge from tip 41). The novel attributes of the present invention are found in the second facets (e.g., the facets that form the ultimate tip 12).

First facets 44, 45 generally define an included angle 46 (or 49) which may preferably be about 35 to about 75 degrees. Included angle 49, as shown, may be determined as half the angle formed between the intersection 47 of extended lines 48 (shown as extending from facets but 44, 45 in dotted lines) of first facets 44, 45 prior to second facets 42, 43 being formed. It should be noted that lines 48 are not part of the substrate 31, serving only to illustrate how the included angle is determined. Included angle 46 may alternately be determined by the angle disposed between a perpendicular or line extension 50 of the blade body 51 to the first facet 44 or 45. Though illustrated at two different locations in the razor, included angle is intended to be substantially identical (e.g., included angle 46 is the same value as angle 49) as they generally represent the same geometry.

The first facets 44, 45 may generally extend a distance 44a of about 175 to about 400 micrometers back from the blade tip 41.

Thus, the present invention contemplates an included angle of about 35 degrees to about 70 degrees in the region of the blade having a distance less than about 4 micrometers back from the blade tip.

A reduced included angle allows the blades to be slimmer at the blade tip (e.g., up to about 2 micrometers back from the blade tip). This, with the geometry (e.g., thicknesses, areas, and volumes) described above, provide a unique combination of sharpness and strength, not recognized in the art.

### Finished Blade (Substrate With Coatings)

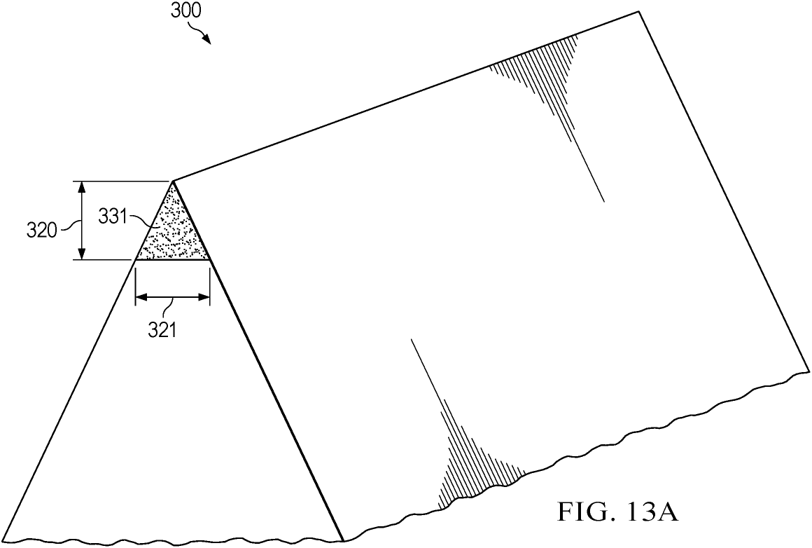

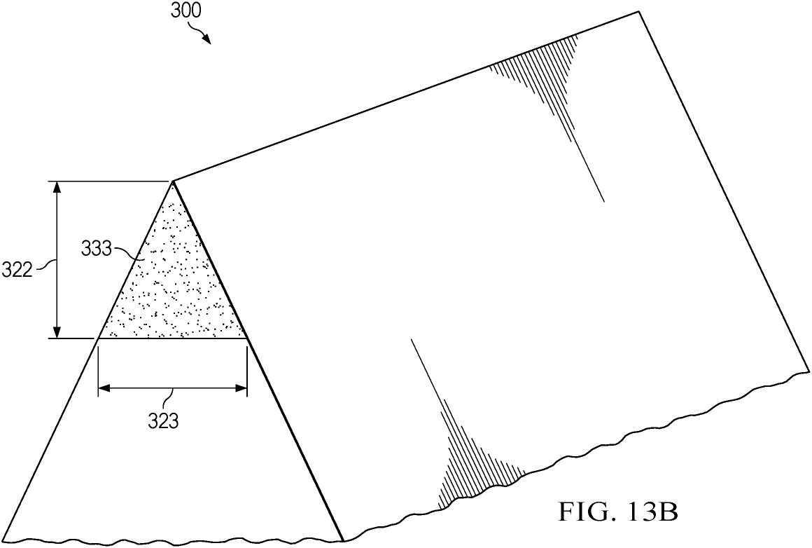

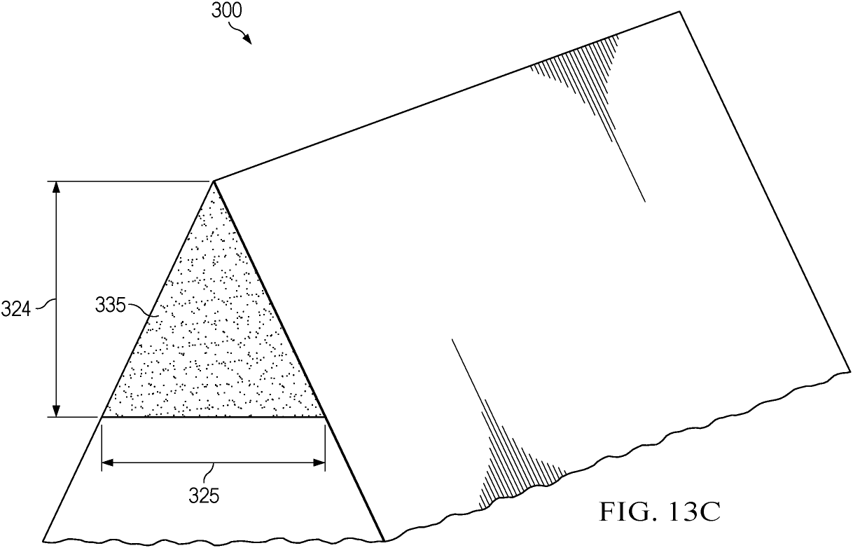

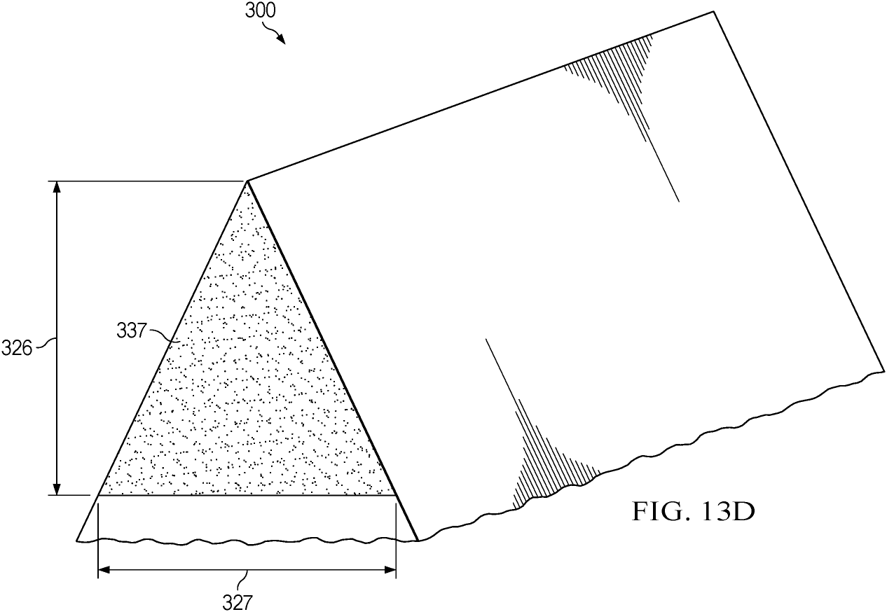

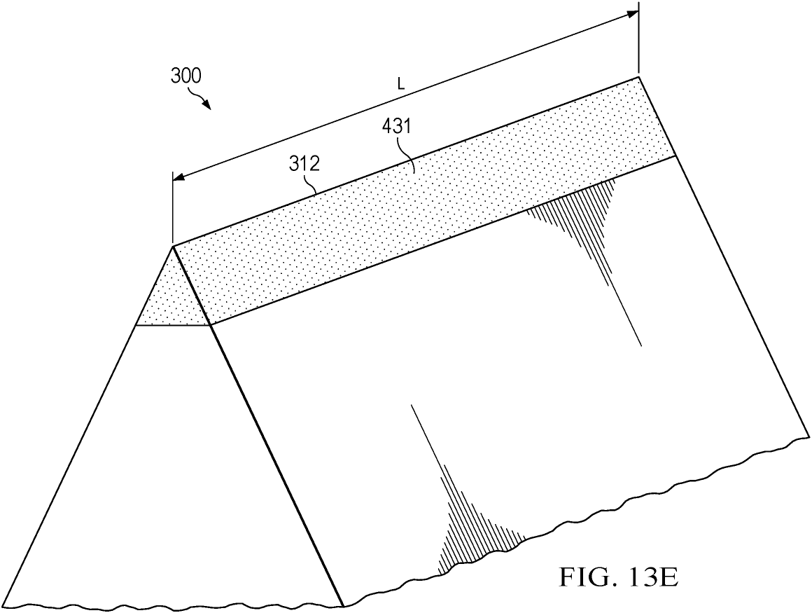

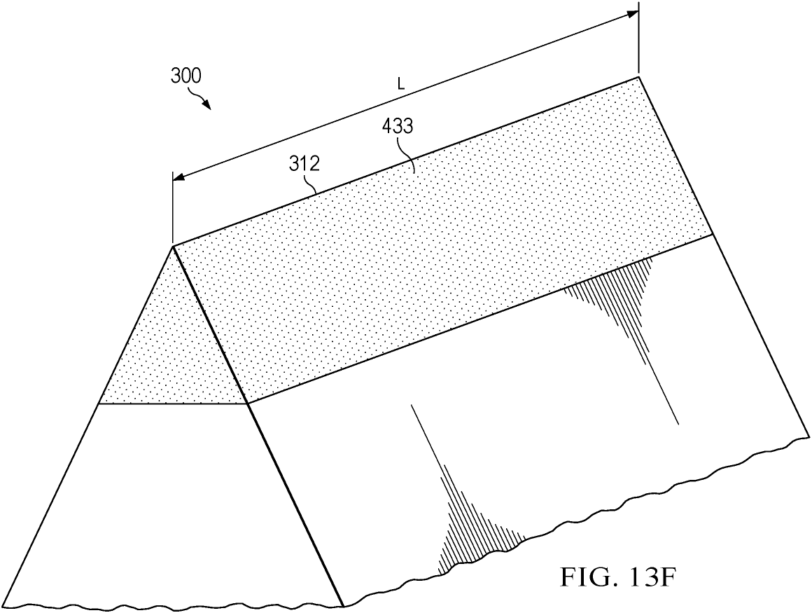

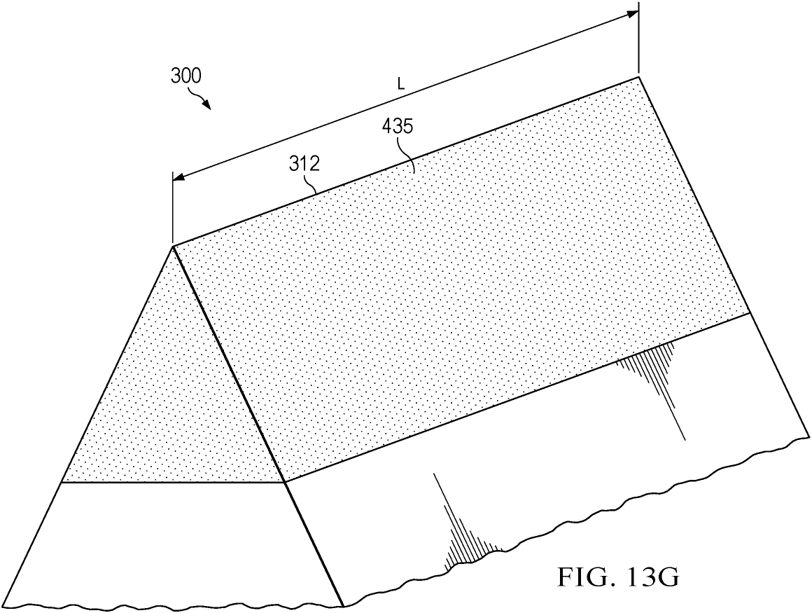

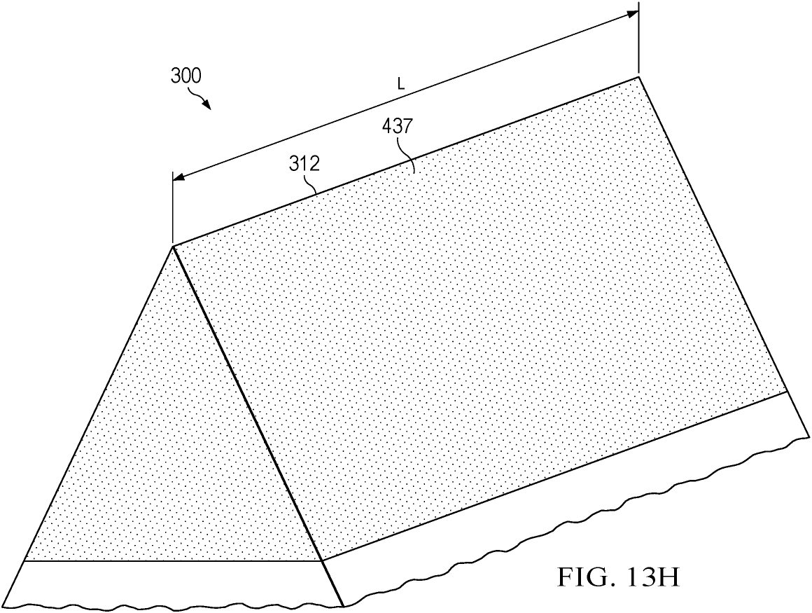

Referring now to FIGS. 13A-13H, there is shown a finished first blade 300 including substrate 11 (e.g., substrate 11 of FIGS. 1-9 depicted), coated with one or more materials, such as interlayer 134, hard coating layer 136, overcoat layer 138, and outer layer 140. The substrate 11 in FIGS. 13A-13H is stainless steel. An example of a razor blade having a substrate, interlayer, hard coating layer, overcoat layer and outer layer is described in U.S. Pat. No. 6,684,513, assigned to the Assignee hereof, and incorporated by reference in its entirety.

Interlayer 134 is generally desirably used to facilitate bonding of the hard coating layer 136 to the substrate 11. Examples of a suitable interlayer material are niobium, titanium, and chromium containing material. A particular interlayer is made of niobium greater than about 100 Angstroms and preferably less than about 500 Angstroms thick. The interlayer may have a thickness from about 150 Angstroms to about 350 Angstroms. PCT 92/03330 describes use of a niobium interlayer.

Hard coating layer 136 provides improved strength, corrosion resistance and shaving ability and can be made from fine∼, micro-, or nano-crystalline carbon-containing materials (e.g., diamond, amorphous diamond or DLC), nitrides (e.g., boron nitride, niobium nitride, chromium nitride, zirconium nitride, or titanium nitride), carbides (e.g., silicon carbide), oxides (e.g., alumina, zirconia) or other ceramic materials (including nanolayers or nanocomposites). The carbon containing materials can be doped with other elements, such as tungsten, titanium, silver, or chromium by including these, additives, for example in the target during application by sputtering. The materials can also incorporate hydrogen, e.g., hydrogenated DLC. Preferably coating layer 136 is made of diamond, amorphous diamond or DLC. A particular embodiment includes DLC less than about 3,000 Angstroms, preferably from about 500 Angstroms to about 1,500 Angstroms, and most preferably from about 300 Angstroms to about 800 Angstroms. DLC layers and methods of deposition are described in U.S. Pat. No. 5,232,568. As described in the “Handbook of Physical Vapor Deposition (PVD) Processing,” “DLC is an amorphous carbon material that exhibits many of the desirable properties of diamond but does not have the crystalline structure of diamond.”

Overcoat layer 138 is generally used to reduce the tip rounding of the hard coated edge and to facilitate bonding of the outer layer to the hard coating while still maintaining the benefits of both. Overcoat layer 138 is preferably made of chromium containing material, e.g., chromium or chromium alloys or chromium compounds that are compatible with polytetrafluoroethylene, e.g., CrPt. A particular overcoat layer is chromium about 100-200 Angstroms thick. Overcoat layer may have a thickness of from about 50 Angstroms to about 500 Angstroms, preferably from about 100 Angstroms to about 300 Angstroms. Razor blade 10 has a cutting edge that has less rounding with repeated shaves than it would have without the overcoat layer.

Outer layer 140 is used to provide reduced friction. The outer layer 140 may be a polymer composition or a modified polymer composition. The polymer composition may be polyfluorocarbon. A suitable polyfluorocarbon is polytetrafluoroethylene sometimes referred to as a telomer. A particular polytetrafluoroethylene material is Chemours LW 2120. This material is a nonflammable and stable dry lubricant that consists of small particles that yield stable dispersions. It is furnished as an aqueous dispersion of 20% solids by weight and can be applied by dipping, spraying, or brushing, and can thereafter be air dried or melt coated. The layer is preferably less than 5,000 Angstroms and could typically be 1,500 Angstroms to 4,000 Angstroms, and can be as thin as 100 Angstroms, provided that a continuous coating is maintained. Provided that a continuous coating is achieved, reduced telomer coating thickness can provide improved first shave results. U.S. Pat. Nos. 5,263,256 and 5,985,459, which are hereby incorporated by reference, describe techniques which can be used to reduce the thickness of an applied telomer layer.

Razor blade 300 is made generally according to the processes described in the above referenced patents. A particular embodiment includes a niobium interlayer 134, DLC hard coating layer 136, chromium overcoat layer 138, and a polytetrafluoroethylene outer coat layer 140. Chromium overcoat layer 138 is deposited to a minimum of 100 Angstroms and a maximum of 500 Angstroms. It is deposited by sputtering using a DC bias (more negative than -50 volts and preferably more negative than -200 volts) and pressure of about 2 millitorr argon. The increased negative bias is believed to promote a compressive stress (as opposed to a tensile stress), in the chromium overcoat layer which is believed to promote improved resistance to tip rounding while maintaining good shaving performance. Razor blade 300 preferably has a tip radius R with the coating deposited thereon of about 200-400 Angstroms, measured by SEM after application of overcoat layer 138 and before adding outer layer 140.

The blade profile geometries, including volume, area, and thickness values determined using atomic force microscopy of the finished razor blade 300 of the present invention are provided below in Tables 4, 5, and 6.

### Finished Blade Thickness

The thickness of the coated blade tip is determined in the same manner as the thickness of the blade tip substrate described above. As shown in FIGS. 13A-13D, distance 320 of 0.5 micrometers back from the coated tip 312 has a width or thickness 321 of about 0.412 micrometers to about 0.525 micrometers. Distance 322 of 1.0 micrometers back from the coated tip 312 has a width or thickness 323 of about 0.616 micrometers to about 0.758 micrometers. Distance 324 of 1.5 micrometers back from the coated tip 312 has a width or thickness 325 of about 0.810 micrometers to about 0.962 micrometers. Distance 326 of 2.0 micrometers back from the coated tip 312 has a width or thickness 327 of about 1.023 micrometers to about 1.173 micrometers.

Table 4 below outlines desired thickness values contemplated in the present invention finished or coated blades for distances back from the blade tip. The units for distance and thickness are micrometers. In addition, Table 4 lists corresponding thickness value ranges measured for prior art razor finished blade edges having the same coatings.

TABLE 4

| Distance from Blade Tip | Coated Blade Tip THICKNESS Present Invention | Coated Blade Tip THICKNESS Prior Art |
|---|---|---|
| 0.1 | 0.167-0.212 | 0.214 |
| 0.2 | 0.244-0.308 | 0.321 |
| 0.3 | 0.309-0.393 | 0.420 |
| 0.4 | 0.365-0.464 | 0.503 |
| 0.5 | 0.412-0.525 | 0.572 |
| 0.6 | 0.456-0.579 | 0.630 |
| 0.7 | 0.498-0.627 | 0.680 |
| 0.8 | 0.538-0.672 | 0.727 |
| 0.9 | 0.578-0.715 | 0.773 |
| 1.0 | 0.616-0.758 | 0.820 |
| 1.1 | 0.655-0.799 | 0.867 |
| 1.2 | 0.693-0.840 | 0.913 |
| 1.3 | 0.731-0.881 | 0.958 |
| 1.4 | 0.770-0.921 | 1.004 |
| 1.5 | 0.810-0.962 | 1.050 |
| 1.6 | 0.850-1.003 | 1.097 |
| 1.7 | 0.892-1.044 | 1.142 |
| 1.8 | 0.934-1.086 | 1.187 |
| 1.9 | 0.978-1.129 | 1.232 |
| 2.0 | 1.023-1.173 | 1.278 |

FIG. 14 is a graph of the thickness values of Table 4 depicting the novel thickness values for the present invention coated razor blade tips and the thickness value ranges of the prior art coated razor blade tips.

As can be seen from the graph in FIG. 14, the present invention blade tip thickness values are lower throughout (e.g., at each point) vis-à-vis the prior art. This thickness differentiation provides the advantage necessary and a direct link to improved shaving performance. As the finished blade of the present invention is intended for use in commercially available products, the coating thickness and other geometries are instrumental for comfort, durability, and cutting ability.

### Finished Blade Area

The area of the finished blade of the present invention is determined in the same manner as described above with respect to the area of the blade tip substrate. As shown in FIGS. 13A-13D, the finished blade 300 (coated substrate 11) of the present invention has an area 331 of between about 1.837 square micrometers to about 2.324 square micrometers measured at a distance 320 of 0.5 micrometers from the blade tip 312.

The finished blade 300 (coated substrate 11) of the present invention has an area 333 of between about 5.179 square micrometers to about 6.511 square micrometers measured at a distance 322 of 1.0 micrometers from the blade tip 312.

The finished blade 300 (coated substrate 11) of the present invention has an area 335 of between about 9.806 square micrometers to about 12.093 square micrometers measured at a distance 324 of 1.5 micrometers from the blade tip 312.

The finished blade 300 (coated substrate 11) of the present invention has an area 337 of between about 15.747 square micrometers to about 19.014 square micrometers measured at a distance 326 of 2 micrometers from the blade tip 312.

Table 5 below outlines desired area values contemplated in the present invention finished blades for distances back from the blade tip. The units for distance are micrometers and the unites for area are square micrometers. In addition, Table 5 lists corresponding area value ranges measured for prior art finished razor blade edges having the same coatings.

TABLE 5

| Distance from Blade Tip | Coated Blade Tip AREA Present Invention | Coated Blade Tip AREA Prior Art |
|---|---|---|
| 0.1 | 0.289-0.359 | 0.368 |
| 0.2 | 0.551-0.690 | 0.710 |
| 0.3 | 0.904-1.139 | 1.184 |
| 0.4 | 1.338-1.688 | 1.774 |
| 0.5 | 1.837-2.324 | 2.461 |
| 0.6 | 2.396-3.034 | 3.230 |
| 0.7 | 3.012-3.814 | 4.072 |
| 0.8 | 3.683-4.656 | 4.979 |
| 0.9 | 4.406-5.555 | 5.949 |
| 1.0 | 5.179-6.511 | 6.980 |
| 1.1 | 6.004-7.521 | 8.074 |
| 1.2 | 6.878-8.585 | 9.232 |
| 1.3 | 7.803-8.694 | 10.446 |
| 1.4 | 8.779-10.870 | 11.730 |
| 1.5 | 9.806-12.093 | 13.051 |
| 1.6 | 10.885-13.369 | 14.440 |
| 1.7 | 12.016-14.698 | 15.893 |
| 1.8 | 13.202-16.083 | 17.405 |
| 1.9 | 14.447-17.519 | 19.973 |
| 2.0 | 15.747-19.014 | 20.609 |

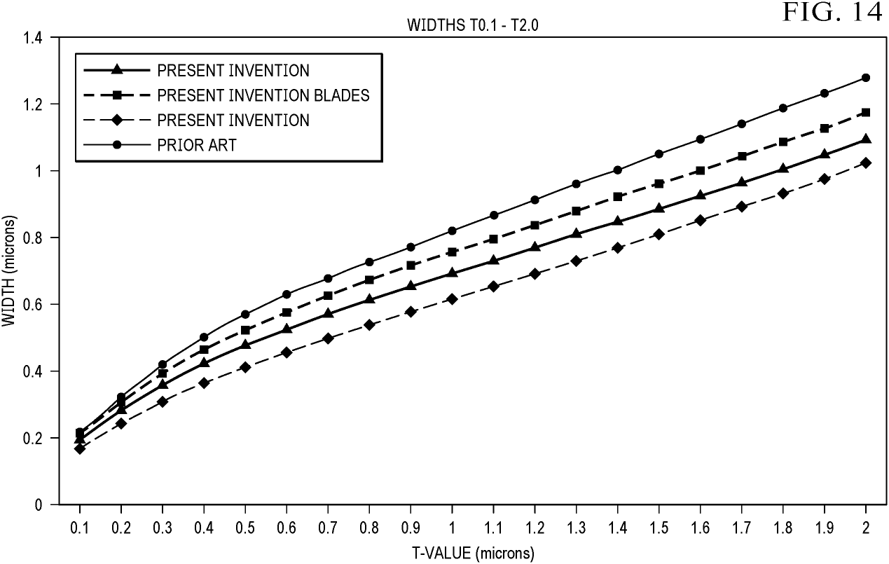

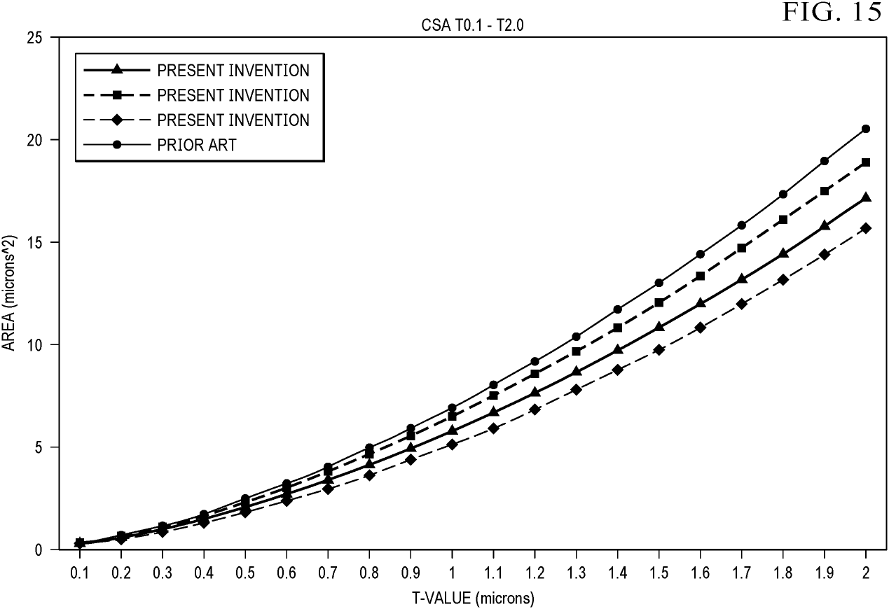

As can be seen from the graph in FIG. 15, which plots data from Table 5, the present invention blade tip area values are lower throughout (e.g., at each point) vis-à-vis the prior art areas. This area differentiation of the coated blade tip renders this blade having improved shaving performance. This is because having a sharp blade (e.g., with a small tip radius) has been surprisingly determined to be not solely enough to provide the best cuts, closeness, and efficiency. If the three-dimensional wedge-shaped substrate has cross-sectional area, and particularly at the ultimate tip, then the cut force of the cutting edge will still be high, producing a less than optimal shave.

### Finished Blade Volume

The volume of the finished blade of the present invention is determined in the same manner as described above with respect to the volume of the blade tip substrate. As shown in FIGS. 13E-13H, the finished blade 300 (coated substrate 11) of the present invention has a volume 431 of between about 3.532 cubic micrometers to about 4.469 cubic micrometers measured at a distance 320 of 0.5 micrometers from the blade tip 312.

The finished blade 300 (coated substrate 11) of the present invention has a volume 433 of between about 9.958 cubic micrometers to about 12.521 cubic micrometers measured at a distance 322 of 1.0 micrometers from the blade tip 312.

The finished blade 300 (coated substrate 11) of the present invention has a volume 435 of between about 18.857 cubic micrometers to about 23.254 cubic micrometers measured at a distance 324 of 1.5 micrometers from the blade tip 312.

The finished blade 300 (coated substrate 11) of the present invention has a volume 437 of between about 30.281 cubic micrometers to about 36.563 cubic micrometers measured at a distance 326 of 2 micrometers from the blade tip 312.

Table 6 below outlines desired volume values contemplated in the present invention finished blades for distances back from the blade tip. The units for distance are micrometers and the units for volume are cubic micrometers. In addition, Table 6 lists corresponding area values measured for prior art razor finished blade edges having the same coatings.

TABLE 6

| Distance from Blade Tip | Coated Blade Tip VOLUME Present Invention | Coated Blade Tip VOLUME Prior Art |
|---|---|---|
| 0.1 | 0.556-0.691 | 0.707 |
| 0.2 | 1.059-1.327 | 1.366 |
| 0.3 | 1.739-2.190 | 2.276 |
| 0.4 | 2.573-3.246 | 3.411 |
| 0.5 | 3.532-4.469 | 4.731 |
| 0.6 | 4.607-5.833 | 6.212 |
| 0.7 | 5.793-7.334 | 7.830 |
| 0.8 | 7.082-8.953 | 9.574 |
| 0.9 | 8.472-10.682 | 11.439 |
| 1.0 | 9.958-12.521 | 13.342 |
| 1.1 | 11.546-14.462 | 15.526 |
| 1.2 | 13.227-16.508 | 17.752 |
| 1.3 | 15.005-18.656 | 20.086 |
| 1.4 | 16.882-20.902 | 22.536 |
| 1.5 | 18.857-23.254 | 25.095 |
| 1.6 | 20.931-25.707 | 27.768 |
| 1.7 | 23.106-28.263 | 30.561 |
| 1.8 | 25.387-30.926 | 33.468 |
| 1.9 | 27.780-33.688 | 36.483 |
| 2.0 | 30.281-36.653 | 39.630 |

As can be seen from the graph in FIG. 16 which plots data of Table 6 the present invention blade tip volume values are lower throughout (e.g., at each point) vis-à-vis the prior art volumes.

The finished blade 300 with substrate 11, together with the geometries noted above provides a noticeable improvement in blade sharpness. The blade sharpness may be quantified by measuring cut force, which correlates with sharpness. As will be described below, the cutting force of the present invention blades is about 10% lower than that of the prior art blades.

### Coated Blade Cut Force

Cut force of a finished blade of the present invention is measured by the wool felt cutter test, which measures the cut forces of the blade by measuring the force required by each blade to cut through wool felt. The cut force of each blade is determined by measuring the force required by each blade to cut through wool felt. Each blade is run through the wool felt cutter 5 times and the force of each cut is measured on a recorder. The lowest of 5 cuts is defined as the cut force. The finished blade 300 of the present invention has wool felt cut force of about 0.9 lbs. This is considered herein to be a blade that can cut hair easily, e.g., a very sharp blade, an improvement over many commercially available blades in the prior art, which disclose cut forces of about 1.1 lbs.

### Single Fiber Cut Force

Cutting forces of the finished blades of the present invention can also be measured by a Single Fiber Cutting test, which measures the cutting forces of the blade by measuring the force required by each blade to cut through a single hair. The cutting force of each blade is determined by measuring the force required by each blade to cut through a single human hair. Each blade cuts the hair greater than 50 times and the force of each cut is measured on a recorder. A control blade population is often used with intermittent cuts, to determine a more reliable cutting force comparison. The hair being cut is fully hydrated. Cut speed is 50 millimeters per second. The blade tip offset from the “skin plane” is 100 micrometers. The blade angle relative to the “skin plane” is generally about 21.5 degrees. The hair orientation relative to the “skin plane” is 90 degrees. The data acquisition rate is 180 kHz. This type of cutting force testing process is described in U.S. Pat. No. 9,255,858, assigned to the Assignee hereof, and incorporated herein by reference.

A comparison of exemplary cut force values of both types of tests between the prior art and the present invention blades is shown below in Table 7. The negative value for the single fiber cut force indicates the difference in hair cut force of the present invention blade versus a control blade which is recorded as a percentage difference.

TABLE 7

| | | |
|---|---|---|
| Cut forces | Present Invention | Prior art |
| Wool Felt | Less than or equal to 1 on average (e.g., 0.9 lbs) | 1.1 to 1.3 lbs |
| Single Fiber Cutter test | -15 to -5% ~10% lower | -5 to +5% |

Other embodiments of finished or coated blades are contemplated in the present invention. For instance, a finished blade may not include an interlayer or an overcoat layer. They may have a hard coating directly deposited on the substrate. Hard coatings such as those comprised of aluminum magnesium boride-based materials, or composites thereof, are described in U.S. Pat. Publication No. 2013/0031794, assigned to the Assignee hereof and incorporated by reference herein may be feasible. Further, if no overcoat layer is present, an outer layer, if needed, may be deposited directly on the hard coating layer.

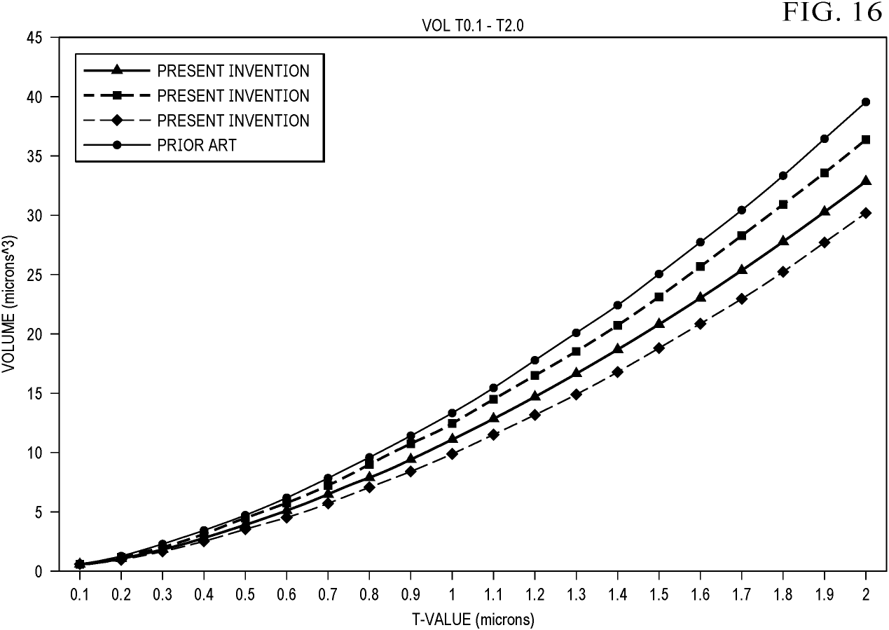

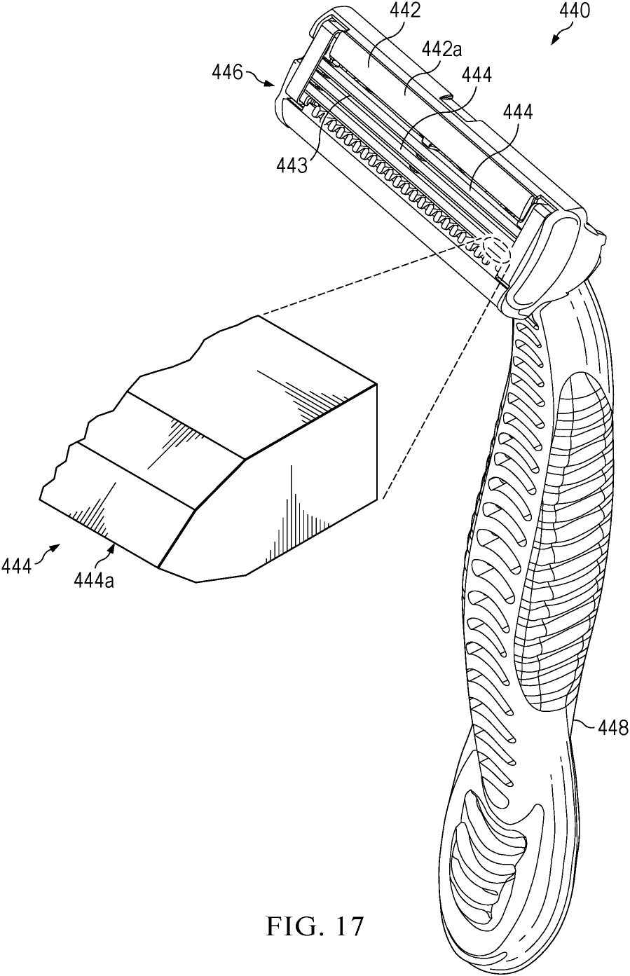

Turning now to FIG. 17, a razor having the finished razor blade of the present invention is shown. Razor 440 generally includes a shaving or cartridge unit 446 attached to a handle 448 with the shaving unit 446 having one or more finished blades 444 (e.g., 3 blades shown) each with a sharpened edge 444a in accordance with the present invention. A cap 442 and guard 443 may also be included in the shaving unit 446, the cap 442 preferably including a shaving aid composite 442a affixed thereon. It is noted that one or more of the blades 444 in FIG. 17 has the novel attributes of volume, area, and thickness and materials disposed thereon, as disclosed herein.

As mentioned throughout, the use of an atomic force microscope is contemplated in the present invention. Spatial information about the razor blades of the present invention, and more specifically the near tip area, may be determined using an atomic force microscope (AFM) 200, as shown in FIGS. 18A-18B, a commercially available instrument capable of non-contact operation with appropriate tips. Atomic force microscopy is a high precision technique, which offers high vertical and lateral resolutions on a wide variety of surface types with vertical resolution that is at least an order of magnitude better than a scanning electron microscope. Referring to FIGS. 18A-18B, AFM 200 can include a probe 205 that preferably has a high aspect ratio of a length 210 of probe 205 to a half side angle 215. For example, the aspect ratio can be at least 1 micron per degree and could be about 1.5 microns per degree. In addition, probe 205 has a probe tip 220 that preferably has a radius R2 that is less than a radius R1 of ultimate tip 12 of tip portion of razor blade 25. For example, the radius R2 of probe tip 220 could be less than or equal to ⅓ the radius R1 of ultimate tip 12 of razor blade 10. The spatial information about razor blade 10 for instance may be obtained for all or part of the tip portion of razor blade 10. For example, spatial information may be obtained for part of the tip portion, e.g., from the ultimate tip 12 to 4 micrometers on each side of ultimate tip 12. In other examples, spatial information may be obtained for an entirety of the tip portion, e.g., from ultimate tip 12 back to where first and second facets join a body portion of the razor blade (not shown).

FIG. 19 illustrates the output 190 of the atomic force microscope of FIGS. 18A-18B when measuring razor blade 10. Shown in FIG. 19 is a three-dimensional representation of a tip portion 192 of razor blade 10 (or coated blade 300) showing example graphical representations of a tip portion 192 including an ultimate tip 12 (or coated tip 312) and facets 14 and 16 as generated by the atomic force microscope’s software-based scripts using the spatial information based on the positional data measured. This three-dimensional representation can be used to determine razor blade tip attributes of the present invention such as volume, area, and thickness. As can be seen in the output, there are no straight lines. For instance, the curve representing the “peak” of each of the subsections is captured by a polynomial, so the dimensions would be different at each point along the substrate.

The illustrations presented herein are not intended to be actual views of any particular substrate, apparatus (e.g., device, system, etc.), or method, but are merely idealized and/or schematic representations that are employed to describe and illustrate various embodiments of the disclosure.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.” The term “about” as used herein generally signifies approximately or around. As one example, when a range of numerals are given, e.g., if “about 4 to about 40” is or “4 to 40” is disclosed herein, the present invention contemplates the recited value of “4” and “40” and a functionally equivalent range surrounding each of the 4 and the 40, which can generally be plus or minus 10 percent of each number. Thus, for clarity, if a reference is described as being “4 to 40” this signifies it could be a functionally equivalent range of 4 and a functionally equivalent range of 40 or “about 4 to about 40.” The latter signifies the range of “3.6 to 44” as being encompassed by the present invention since the range of 3.6 to 4.4 represents plus and minus 10 percent of 4, respectively and the range of 36 to 44 represents plus and minus 10 percent of 40, respectively.

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests, or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover, in the appended claims, all such changes and modifications that are within the scope of this invention.

What is claimed is:

1. A razor blade comprising a substrate with a cutting edge being defined by an ultimate tip, said substrate comprising a thickness of between 0.135 micrometers to 0.138 micrometers at a distance of 0.1 micrometers from the ultimate tip.

2. The razor blade of claim 1 further comprising a thickness of between 0.199 and 0.203 at a distance of 0.2 micrometers from said ultimate tip, a thickness of between 0.256 micrometers to 0.259 micrometers from the ultimate tip at a distance of 0.3 micrometers from said ultimate tip, a thickness of between 0.307 micrometers and 0.308 micrometers at a distance of 0.4 micrometers from said ultimate tip, and a thickness of between 0.351 micrometers and 0.355 micrometers at a distance of 0.5 micrometers from the ultimate tip.

3. The razor blade of claim 1 further comprising a thickness of between 0.392 and 0.398 at a distance of 0.6 micrometers from said ultimate tip, a thickness of between 0.431 micrometers to 0.439 micrometers from the ultimate tip at a distance of 0.7 micrometers from said ultimate tip, a thickness of between 0.470 micrometers and 0.479 micrometers at a distance of 0.8 micrometers from said ultimate tip, and a thickness of between 0.509 micrometers and 0.519 micrometers at a distance of 0.9 micrometers from the ultimate tip.

4. The razor blade of claim 1 further comprising a thickness of between 0.547 and 0.557 at a distance of 1 micrometer from the ultimate tip.

5. The razor blade of claim 1 further comprising a thickness of between 0.586 and 0.596 at a distance of 1.1 micrometers from said ultimate tip, a thickness of between 0.625 micrometers to 0.634 micrometers from the ultimate tip at a distance of 1.2 micrometers from said ultimate tip, a thickness of between 0.664 micrometers and 0.673 micrometers at a distance of 1.3 micrometers from said ultimate tip, and a thickness of between 0.705 micrometers and 0.712 micrometers at a distance of 1.4 micrometers from the ultimate tip.

6. The razor blade of claim 1 further comprising a thickness of 0.747 micrometers and 0.751 micrometers at a distance of 1.5 micrometers from said ultimate tip and a thickness of between 0.957 micrometers and 0.977 micrometers at a distance of 2 micrometers from the ultimate tip.

7. The razor blade of claim 1 wherein said thicknesses are measured using an Atomic Force Microscope.

8. The razor blade of claim 1 wherein a tip radius of said razor blade ranges from 100 to 500 Angstroms.

9. The razor blade of claim 1, further comprising an included angle of about 45 to about 65 degrees measured at a distance of 0.3 micrometers back from said sharpened tip.

10. A razor blade comprising a coated substrate with a cutting edge being defined by a coated tip, said coated substrate having a thickness of between 0.167 micrometers to 0.212 micrometers at a distance of 0.1 micrometers from said coated tip.

11. The razor blade of claim 10 further comprising a thickness of between 0.244 and 0.308 at a distance of 0.2 micrometers from said coated tip.

12. The razor blade of claim 10 further comprising a thickness of between 0.412 micrometers to 0.525 micrometers at a distance of 0.5 micrometers from said coated tip, a thickness of between 0.616 micrometers to 0.758 micrometers at a distance of 1 micrometer from said coated tip.

13. The razor blade of claim 10 further comprising a thickness of between 0.810 micrometers to 0.962 micrometers at a distance of 1.5 micrometers from said coated tip, a thickness of between 1.023 micrometers to 1.173 micrometers at a distance of 2 micrometers from said coated tip.

14. The razor blade of claim 10 wherein said thicknesses are measured using an Atomic Force Microscope.

15. The razor blade of claim 10 wherein said coated substrate is coated with one or materials.

16. The razor blade of claim 15 wherein said one or more materials comprises niobium, chromium, carbon, boron, titanium, or polymer containing materials.

17. The razor blade of claim 10 wherein a wool cut force of said razor blade is about 0.9 lbs.

18. A razor blade comprising a substrate having a cutting edge with a sharpened tip, said substrate having a thickness measured at a distance of 4 microns from the sharpened tip of about 1.20 micrometers to about 1.60 micrometers.

19. The razor blade of claim 18 further comprising a thickness measured at a distance of 1 micrometer back from the sharpened tip ranging from about 0.547 micrometers to about 0.557 micrometers, a thickness measured at a distance of 2 micrometers from the sharpened tip of about 0.957 micrometers to about 0.977 micrometers, and a thickness measured at a distance of 3 microns from the sharpened tip of 0.90 micrometers to 1.19 micrometers.

20. The razor blade of claim 19 wherein said thicknesses form a non-linear relationship relative to each other as measured using an Atomic Force Microscope.
